(19) United States
(12) Patent Application Publication
(10) Pub. No.: US 2010/0190063 A1
(43) Pub. Date: Jul. 29, 2010

(54) METHOD AND APPARATUS FOR MANUFACTURING MEMBER FOR SECONDARY BATTERY AND SECONDARY BATTERY USING THE SAME

(76) Inventors: Yusuke Fukumoto, Osaka (JP); Tetsuya Hayashi, Osaka (JP); Kazunori Kubota, Osaka (JP)

Correspondence Address: MCDERMOTT WILL & EMERY LLP, 600 13TH STREET, NW, WASHINGTON, DC, 20005-3096, US

(21) Appl. No.: 11/916,170

(22) PCT Filed: Jun. 18, 2007
(86) PCT No.: PCT/JP2007/062216

§ 371 Date: Nov. 30, 2007

(30) Foreign Application Priority Data
Jul. 6, 2006 (JP) 2006-186418
Jul. 6, 2006 (JP) 2006-186419
Jul. 6, 2006 (JP) 2006-186420

(51) Int. Cl. H01M 10/02; H01M 10/04

(52) U.S. Cl. 429/246; 427/58; 118/258

(57) ABSTRACT

At least (i) dispersing and mixing inorganic oxide filler, solvent and binder so as to produce a coating paint; (ii) supplying the coating paint to a gravure coater; and (iii) coating the coating paint to member via a gravure roll are included. The (i) or (ii) includes allowing the coating paint to stand still and removing an aggregate and a precipitate of inorganic oxide filler.

### TECHNICAL FIELD

The present invention relates to a method for manufacturing a member such as a positive electrode, a negative electrode and a separator for a secondary battery. In particular, it relates to a method and apparatus for manufacturing a member for a secondary battery having a uniform and homogenous insulating porous protective layer and to a secondary battery using the same.

### BACKGROUND ART

Recently, with the widespread use of portable and cordless electronic equipment, there has been a strong demand for compact, lightweight and high energy density secondary battery as a driving power source. Under such circumstances, developments of technologies for thinning an electrode have been increasingly carried out. In addition, safety technologies for forming a porous protective layer on the surface of a negative electrode, a positive electrode or a separator as a member for a secondary battery so as to secure a heat resistance property and prevent short circuit have been proposed (see, for example, patent document 1). Patent document 1 describes a porous protective layer including a resin binder and insulating fine particles of alumina and the like.

However, conventionally, in a coating paint (hereinafter, also referred to as “paint”) used for coating formation of a porous protective layer, many aggregates of particles are generated because the size of alumina particles to be mixed is in the submicron order. Furthermore, in the case where inexpensive particle materials are used, large-diameter particles (coarse powders) larger than the coating thickness may be mixed in the materials from the beginning.

In accordance with the technology of patent document 1, as shown in FIGS. 12A and 12B, when porous protective layer 561 is formed on base material 560 by coating by gravure printing with the use of a conventional coating paint, a coating film defect such as coating streak 562a and grain 562b is generated in porous protective layer 561 due to aggregates or coarse powders of a filler in the coating paint. As a result, there have been problems, for example, the yield of the member for a secondary battery is reduced, or the safety or the reliability is reduced due to variation in the distance between electrodes when a battery is produced. Furthermore, the thickness of porous protective layer 61 depends upon the size of an aggregate, it was difficult to form a uniform and thinner film. Therefore, how to remove coarse powders or aggregates in a coating paint to be used was a great problem to be solved.

One of solutions to the problem is a technology for preventing the formation of aggregates in a paint before the paint is applied to a member by providing a circulation line for returning the paint to a stirrer by way of a filter in addition to a paint supplying line for supplying the paint to a coater equipped with a stirrer (see, for example, patent document 2).

Furthermore, a technology of providing a thixotropy imparting agent in order to suppress aggregation is disclosed (see, for example, patent document 3).

However, in the case where a porous protective layer is formed by coating by gravure printing in accordance with the technology of patent document 1, since the diameter of the filler is in the submicron order, in particular, when the storage time of the coating paint is increased, aggregation of the filler occurs and aggregates and precipitates are formed in the coating paint in a coating solution pan. Furthermore, in the case where inexpensive filler materials are used, coarse powders larger than the thickness of a film to be coated may be mixed in the filler from the beginning. Consequently, when aggregates or precipitates are placed on a rotating gravure roll, formation of a streak-shaped uncoated portion or a grain of precipitate and the like is transferred to the surface of a base material as a member for a battery. As a result, in particular, when a thin porous protective layer is formed by, for example, gravure printing after the coating paint is stored in the coating solution pan for a long time, many coating film defects such as coating streaks and grains are generated due to aggregates and precipitates. Accordingly, a member for a battery, in which a porous protective layer having an ununiform film thickness is formed, is produced. Therefore, the yield is reduced due to reproduction or waste of a defective member for a battery. Furthermore, when a secondary battery is produced by using a member for a battery having the above-mentioned coating film defects, the battery characteristics, reliability, safety, and the like, are reduced. Furthermore, due to the precipitation of aggregates and coarse powders generated over time, the composition ratio of the coating paint is changed sequentially. Therefore, the film porosity and the like is changed depending upon a production time or a storage time of the coating paint used for gravure printing, thus making it impossible to produce a uniform secondary battery stably.

Furthermore, a circulation-filtration line as described in patent document 2 requires an additional device in addition to a supplying line to a gravure coater. Accordingly, not only the size of equipment but also an equipment cost and a running cost are increased.

Furthermore, in general, in the case where a porous protective layer is formed by coating, the viscosity of the coating paint is low in many cases. Therefore, even if a circulation line is provided in a gravure coater, in a portion of the circulation line (for example, a curved portion of a piping) in which the flow of the coating paint is prevented and the coating paint easily retains, aggregation and precipitation of alumina particles and the like occur. In the worst case, the circulation line may be clogged by precipitates. Moreover, since the circulation line suppresses only the generation of aggregation by circulating the coating paint, when the coating paint returns to a coating solution pan of the gravure coater from the circulation line, aggregation starts again.

Furthermore, for developing a thixotropy imparting agent described in patent document 3, it is necessary to check the effect on the battery performance after a battery is completed. Accordingly, it takes a long time to develop it. Furthermore, a thixotropy imparting agent is not basically almighty, it is required to be developed while it is adjusted with other materials to be used.

[Patent Document 1] Japanese Patent Unexamined Publication No. H7-220759.

[Patent Document 2] Patent Publication No. 3635170

[Patent Document 3] Japanese Patent Unexamined Publication No. 2001-266855

### SUMMARY OF THE INVENTION

A method for manufacturing a member for a secondary battery of the present invention includes at least the steps of (i) dispersing and mixing an inorganic oxide filler, a solvent and a binder so as to produce a coating paint; (ii) supplying the coating paint to a gravure coater; and (iii) coating the coating paint to a member via a gravure roll. The step (i) or (ii) includes allowing the coating paint to stand still and removing an aggregate and a precipitate of the inorganic oxide filler.

Thus, at the time of production or during still standing storage in the gravure coater of the coating paint, aggregates and a precipitates of the inorganic oxide filler in the coating paint are removed. As a result, by using a gravure printing method, it is possible to manufacture a member for a secondary battery which has a homogeneous porous protective layer with a uniform thickness and small composition change and which is excellent in the safety and the reliability in a high yield.

Furthermore, an apparatus for manufacturing a member for a secondary battery of the present invention includes a dispersion device for dispersing and mixing a coating paint including an inorganic oxide filler, a solvent and a binder; and a gravure coater including a precipitation tank and a gravure roll to which the coating paint is supplied. The dispersion device or the gravure coater is provided with a collection portion for collecting aggregates and precipitates of the inorganic oxide filler.

Thus, it is possible to realize a small and inexpensive apparatus for manufacturing a member for a secondary battery, which is capable of manufacturing the member stably without adding large circulation equipment or filter equipment.

### BRIEF DESCRIPTION OF THE DRAWINGS

FIG. 1 is a conceptual sectional view showing a configuration of a secondary battery in accordance with a first exemplary embodiment of the present invention.

FIG. 2 is a flowchart showing a method for manufacturing a member for a secondary battery in accordance with the first exemplary embodiment of the present invention.

FIG. 3 is a conceptual sectional view showing a configuration of a dispersion device of an apparatus for manufacturing a member for a secondary battery in accordance with the first exemplary embodiment of the present invention.

FIG. 4A is a conceptual sectional view showing a configuration of a gravure coater of the apparatus for manufacturing a member for a secondary battery in accordance with the first exemplary embodiment of the present invention.

FIG. 4B is a conceptual sectional view showing a process and an apparatus for manufacturing a member for a secondary battery in accordance with the first exemplary embodiment of the present invention.

FIG. 5 is a flowchart showing another example of a method for manufacturing a member for a secondary battery in accordance with the first exemplary embodiment of the present invention.

FIG. 6 is a conceptual sectional view showing another configuration of a dispersion device of the apparatus for manufacturing a member for a secondary battery in accordance with the first exemplary embodiment of the present invention.

FIG. 7 is a flowchart showing a method for manufacturing a member for a secondary battery in accordance with a second exemplary embodiment of the present invention.

FIG. 8A is a conceptual sectional view showing a gravure coater of an apparatus for manufacturing a member for a secondary battery in accordance with the second exemplary embodiment of the present invention.

FIG. 8B is a conceptual sectional view taken along line 8B-8B of FIG. 8A.

FIG. 9 is a conceptual sectional view showing a process and an apparatus for manufacturing a member for a secondary battery in accordance with the second exemplary embodiment of the present invention.

FIG. 10 is a flowchart showing a method for manufacturing a member for a secondary battery in accordance with a third exemplary embodiment of the present invention.

FIG. 11 is a conceptual sectional view showing a first precipitation tank of an apparatus for manufacturing a member for a secondary battery in accordance with the third exemplary embodiment of the present invention.

FIG. 12A is a conceptual plan view showing a state of an insulating porous protective layer formed of a paint in accordance with a conventional manufacturing method.

FIG. 12B is a conceptual sectional view taken along line 12B-12B of FIG. 12.

### REFERENCE MARKS IN THE DRAWINGS

1 negative electrode
2 positive electrode
3 separator
4 electrode group
5 case
6 sealing plate
7 gasket
8, 9 lead
10, 11 insulating plate
12, 14 current collector
13 negative electrode mixture layer
15 positive electrode mixture layer
21, 321 inorganic oxide filler
22, 322 solvent
23, 323 binder
25, 325 coating paint
26, 326 negative electrode precursor
27, 327, 427 aggregate
30, 300 gravure coater
31, 51 mixing tank
32, 55, 332 coating solution pan (precipitation tank, second precipitation tank)
33, 53 dispersion blade
34a, 54a, 334a, 434a funnel-shaped portion
34, 54, 334, 434 collection portion
35, 57 stirring blade
36, 336 gravure roll (cylinder)
43, 343 doctor blade
44, 344 roll
56 storage tank
100, 200 dispersion device
428 coarse powder
432 first precipitation tank
433 stirrer

### DETAILED DESCRIPTION OF THE PREFERRED EMBODIMENTS

Hereinafter, the exemplary embodiments of the present invention are described with reference to drawings. Note here that the present invention is not particularly limited to the below described contents as long as it is based on the basic prefectures described in this specification.

### First Exemplary Embodiment

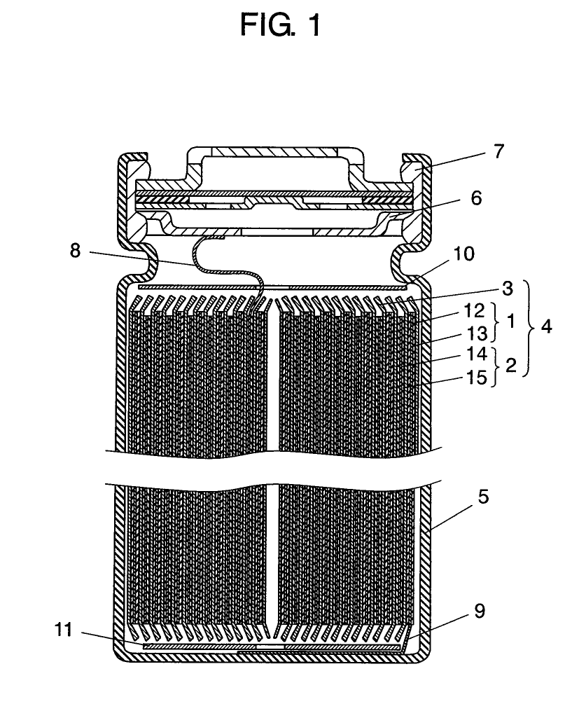

FIG. 1 is a conceptual sectional view showing a configuration of a secondary battery in accordance with a first exemplary embodiment of the present invention.

As shown in FIG. 1, for example, a cylindrical secondary battery includes negative electrode 1, positive electrode 2 facing negative electrode 1 and reducing a lithium ion at the time of discharge, and separator 3 interposed between negative electrode 1 and positive electrode 2 and preventing negative electrode 1 and positive electrode 2 from being brought into direct contact with each other. Negative electrode 1 and positive electrode 2 are wound together with separator 3 so as to form electrode group 4. Electrode group 4 is accommodated in case 5 together with a nonaqueous electrolyte solution (not shown). Insulating plates 10 and 11 made of resin, for separating electrode group 4 from sealing plate 6 and separating leads 8 and 9 from case 5, are disposed in the upper and lower parts of electrode group 4. Insulating gasket 7 for preventing liquid leakage is provided between peripheral part of case 5 and sealing plate 6 in the upper part of case 5.

Negative electrode 1 includes current collector 12 and negative electrode mixture layers 13 including a negative electrode active material and formed on both surfaces of current collector 12. One end of lead 9 is attached to current collector 12. The other end of lead 9 is coupled by welding to case 5 that also works as a negative terminal.

In the first exemplary embodiment, an insulating porous protective layer (not shown) is provided on the surface of negative electrode mixture layer 13 of negative electrode 1. The insulating porous protective layer is formed by using a coating paint by a manufacturing method mentioned below.

Positive electrode 2 includes current collector 14 and positive electrode mixture layers 15 including a positive electrode active material and formed on both surfaces of the current collector 14. One end of lead 8 is attached to current collector 14. The other end of lead 8 is coupled by welding to sealing plate 6 at the side of the positive terminal.

Negative electrode mixture layer 13 includes at least a negative electrode active material capable of inserting and extracting lithium ions. As this negative electrode active material, a carbon material such as graphite or amorphous carbon can be used. Furthermore, it is possible to use materials, for example, silicon (Si), tin (Sn), or the like, which are capable of inserting and extracting a large amount of lithium ions at a lower potential as compared with the positive electrode active material. Such materials can exert the effect of the present invention regardless of whether such a material is any of an elemental substance, an alloy, a compound, a solid solution and a composite active material containing a silicon-containing material or a tin-containing material. In particular, the silicon-containing material is preferable because it has a large capacity density and is inexpensive. An example of the silicon-containing material may include Si, SiOₓ (0.05<x<1.95), or an alloy, a compound or a solid solution of any of the above-mentioned materials in which a part of Si is replaced with at least one element selected from the group consisting of B, Mg, Ni, Ti, Mo, Co, Ca, Cr, Cu, Fe, Mn, Nb, Ta, V, W, Zn, C, N and Sn. An example of the tin-containing materials may include Ni₂Sn₄, Mg₂Sn, SnOₓ (0<x<2), SnO₂, SnSiO₃, LiSnO, and the like.

A negative electrode active material may be formed of these materials singly or in combination with plural kinds of materials. An example of formation of a negative electrode active material by using plural kinds of materials mentioned above may include a compound containing Si, oxygen and nitrogen or a composite of plurality of compounds containing Si and oxygen with different constituting ratio of Si and oxygen. Among them, SiOₓ (0.3×1.3) is preferable because it has a large discharge capacity density and a smaller swelling degree at the charging time as compared with the case where a Si elemental substance is used.

Negative electrode active material layer 23 further includes a binder. An example of the binder may include, for example, polyvinylidene-fluoride (PVDF), polytetrafluoroethylene, polyethylene, polypropylene, aramid resin, polyamide, polyimide, polyamide-imide, polyacrylonitrile, polyacrylic acid, polymethylacrylate ester, polyethylacrylate ester, polyhexylacrylate ester, polymethacrylic acid, polymethylmethacrylate ester, polyethylmethacrylate ester, polyhexylmethacrylate ester, polyvinylacetate, polyvinylpyrrolidone, polyether, polyethersulfone, polyhexafluoropropylene, styrene-butadiene rubber, carboxymethylcellulose, and the like. Furthermore, a copolymer of two or more kinds of materials selected from tetrafluoroethylene, hexafluoroethylene, hexafluoropropylene, perfluoro-alkylvinyl ether, vinylidenefluoride, chlorotrifluoroethylene, ethylene, propylene, pentafluoropropylene, fluoromethylvinyl ether, acrylic acid, hexadiene, may be used.

Furthermore, if necessary, a conductive agent may be mixed in the negative electrode active material layer. An example of the conductive agent includes graphites including natural graphites such as flake graphites, artificial graphites, and expanded graphites; carbon blacks such as acetylene black, Ketjen black, channel black, furnace black, lampblack and thermal black; conductive fibers such as carbon fibers and metal fibers; metal powders of copper, nickel, or the like; organic conductive materials such as polyphenylene derivative, and the like.

For current collector 12 of negative electrode 1 and lead 9, a metal foil of stainless steel, nickel, copper, titanium, and the like, and a thin film of, for example, carbon and conductive resin can be used. Furthermore, surface treatment may be carried out by using carbon, nickel, titanium, and the like.

Positive electrode active material layer 15 includes a lithium-containing composite oxide such as LiCoO₂, LiNiO₂, and LiMn₂O₄ or a mixture thereof or a composite compound thereof, as a positive electrode active material. In particular, LiₓM_{y}N_{1-y}O₂ (in the formula, M and N denote at least one selected from Co, Ni, Mn, Cr, Fe, Mg, Al and Zn, contain at least Ni, and satisfy M≠N. 0.98≦x≦1.10 and 0<y<1 are satisfied) is preferable because the capacity density is large. As the positive electrode active material, besides the above-mentioned materials, olivine-type lithium phosphate expressed by the general formula: LiMPO₄ (M=V, Fe, Ni or Mn) and lithium fluorophosphate expressed by the general formula: Li₂ MPO₄F (M=V, Fe, Ni or Mn) can be used. Furthermore, a part of these lithium-containing compounds may be replaced with a different atom. Surface treatment may be carried out by using metal oxide, lithium oxide, conductive agent, and the like. A surface may be treated to have a hydrophobic property.

Positive electrode active material layer 15 further includes a conductive agent and a binder. An example of the conductive agent may include graphites including natural graphites and artificial graphites; carbon blacks such as acetylene black, Ketjen black, channel black, furnace black, lampblack and thermal black; conductive fibers such as carbon fiber and metal fiber; carbon fluoride; metal powders such as aluminum powders; conductive whiskers of zinc oxide, potassium titanate, and the like; conductive metal oxide such as titanium oxide; an organic conductive material such as phenylene derivatives, and the like. An example of the binder may include, for example, PVDF, polytetrafluoroethylene, polyethylene, polypropylene, aramid resin, polyamide, polyimide, polyamide-imide, polyacrylonitrile, polyacrylic acid, polymethylacrylate ester, polyethylacrylate ester, polyhexylacrylate ester, polymethacrylic acid, polymethylmethacrylate ester, polyethylmethacrylate ester, polyhexylmethacrylate ester, polyvinylacetate, polyvinylpyrrolidone, polyether, polyethersulfone, hexafluoropolypropylene, styrene-butadiene rubber, carboxymethylcellulose, and the like. Furthermore, a copolymer of two or more kinds of materials selected from tetrafluoroethylene, hexafluoroethylene, hexafluoropropylene, perfluoro-alkylvinyl ether, vinylidenefluoride, chlorotrifluoroethylene, ethylene, propylene, pentafluoropropylene, fluoromethylvinyl ether, acrylic acid, hexadiene, may be used. Furthermore, a mixture including two or more of them may be used.

As current collector 14 of positive electrode 2 and lead 8, aluminum (Al), carbon, conductive resin, and the like, can be used. Furthermore, any of these materials, which have been subjected to surface treatment with carbon and the like, may be used.

As case 5 that works as a negative electrode, a metal foil of stainless steel, nickel, copper, titanium, and the like, carbon, and conductive resin can be used. Furthermore, surface treatment may be carried out by using carbon, nickel, titanium, and the like.

At least in a case where an electrolyte solution is used, it is preferable that separator 3 is disposed between positive electrode 2 and negative electrode 1 and impregnated with the electrolyte solution. As the separator, a separator formed of a nonwoven fabric or microporous membrane of polyethylene, polypropylene, aramid resin, amide-imide, polyphenylene sulfide, polyimide, and the like, may be used.

As the nonaqueous electrolyte, a nonaqueous solution based electrolyte solution in which a solute is dissolved in an organic solvent, and a so-called polymer electrolyte layer including these solutions and immobilized with a polymer can be used.

The material of the nonaqueous electrolyte is selected based on the oxidation-reduction potential of the active material. The solute preferred to be used as a nonaqueous electrolyte includes LiPF₆, LiBF₄, LiClO₄, LiAlCl₄, LiSbF₆, LiSCN, LiCF₃SO₃, LiN(CF₃CO₂)₂, LiN(CF₃SO₂)₂, LiAsF₆, LiB₁₀Cl₁₀, lower aliphatic lithium carboxylate, LiF, LiCl, LiBr, LiI, chloroborane lithium, borates such as lithium bis(1,2-benzenedioleate(2-)-O,O′) borate, lithium bis(2,3-naphthalenedioleate(2-)-O,O′) borate, lithium bis(2,2′-biphenyldioleate(2-)-O,O′) borate, lithium bis(5-fluoro-2-oleate-1-benzenesulfonate-O,O′) borate, and lithium tetraphenyl borate, and the like. Salts generally used for a lithium battery can be applied.

Furthermore, an example of the organic solvent for dissolving the above-mentioned salts can include ethylene carbonate (EC), propylene carbonate, butylene carbonate, vinylene carbonate, dimethyl carbonate (DMC), diethyl carbonate, ethyl methyl carbonate (EMC), dipropyl carbonate, methyl formate, methyl acetate, methyl propionate, ethyl propionate, dimethoxymethane, γ-butyrolactone, γ-valerolactone, 1,2-diethoxyethane, 1,2-dimethoxyethane, ethoxymethoxyethane, trimethoxy methane, tetrahydrofuran, tetrahydrofuran derivative such as 2-methyltetrahydrofuran, dimethyl sulfoxide, 1,3-dioxolane, dioxolane derivative such as 4-methyl-1,3-dioxolane, formamide, acetamide, dimethylformamide, acetonitrile, propyl nitrile, nitromethane, ethyl monoglyme, phosphotriester, acetic acid ester, propionic acid ester, sulfolane, 3-methyl sulfolane, 1,3-dimethyl-2-imidazolidinone, 3-methyl-2-oxazolidinone, propylene carbonate derivative, ethyl ether, diethyl ether, 1,3-propanesultone, anisole, fluorobenzene, and a mixture of two or more of them. Solvents generally used in a lithium battery can be applied.

Furthermore, additives such as vinylene carbonate, cyclohexylbenzene, biphenyl, diphenyl ether, vinyl ethylene carbonate, divinyl ethylene carbonate, phenylethylene carbonate, diallyl carbonate, fluoroethylene carbonate, catechol carbonate, vinyl acetate, ethylene sulfite, propanesultone, trifluoropropylene carbonate, dibenzofuran, 2,4-difluoroanisole, o-terphenyl, m-terphenyl, and the like, may be included.

The nonaqueous electrolyte may be used as a solid electrolyte by mixing one polymer material or a mixture of two or more of the polymer materials with the above-mentioned solute. An example of the polymer material includes polyethylene oxide, polypropylene oxide, polyphosphazene, polyaziridine, polyethylene sulfide, polyvinyl alcohol, polyvinylidene-fluoride, polyhexafluoropropylene, and the like. Furthermore, the nonaqueous electrolyte may be used in a gel state by mixing with the above-mentioned organic solvents. Furthermore, an inorganic material such as lithium nitride, lithium halide, lithium oxoate, Li₄SiO₄, Li₄SiO₄—LiI—LiOH, Li₃PO₄—Li₄SiO₄, Li₂SiS₃, Li₃PO₄—Li₂S—SiS₂, and a phosphorus sulfide compound may be used as the solid electrolyte.

The insulating porous protective layer is formed as follows. A coating paint is allowed to stand still and stored in a mixing tank in which at least inorganic oxide filler, solvent and binder are dispersed and mixed as mentioned below, and aggregates and coarse powders of the inorganic oxide filler are removed. Thereafter, the coating paint is gravure-printed by a gravure coater so as to form a porous protective layer on the surface of negative electrode mixture layer 13 of negative electrode 1.

Then, negative electrode 1 having the insulating porous protective layer formed thereon and positive electrode 2 are wound with separator 3 interposed therebetween. Thus, it is possible to realize a secondary battery that is excellent in the safety and the reliability such as a heat resistance property.

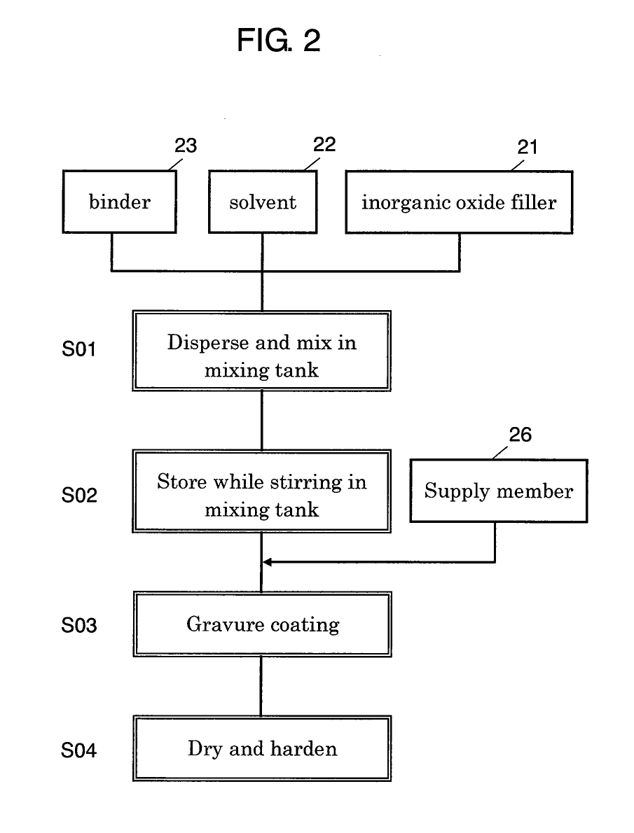

Hereinafter, a method for manufacturing a member for a secondary battery used for forming an insulating porous protective layer is described with reference to FIGS. 2, 3 to 4B.

FIG. 2 is a flowchart showing a method for manufacturing a member for a secondary battery in accordance with the first exemplary embodiment of the present invention.

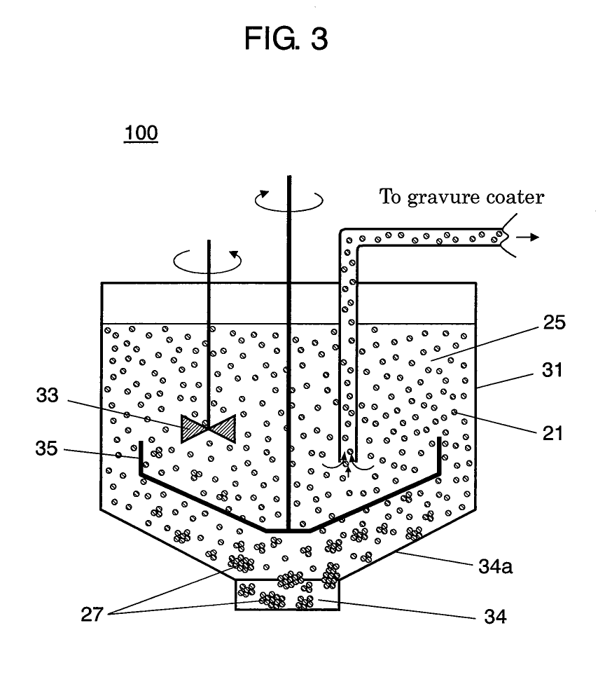

FIG. 3 is a conceptual sectional view showing a configuration of dispersion device 100 of an apparatus for manufacturing a member for a secondary battery in accordance with the first exemplary embodiment of the present invention.

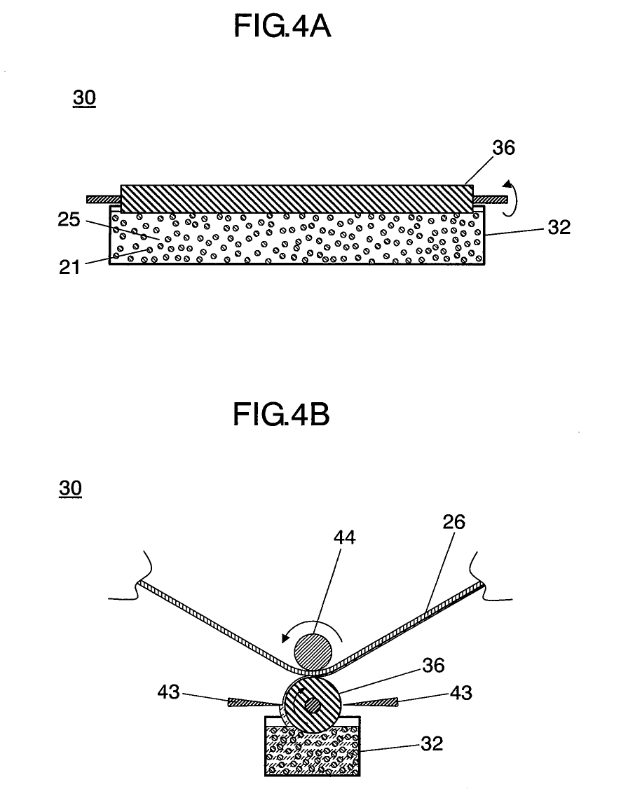

FIG. 4A is a conceptual sectional view showing a configuration of a gravure coater of the apparatus for manufacturing a member for a secondary battery in accordance with the first exemplary embodiment of the present invention. FIG. 4B is a conceptual sectional view showing a process and the apparatus for manufacturing a member for a secondary battery in accordance with the first exemplary embodiment of the present invention.

Firstly, as shown in FIGS. 2 and 3, for example, at least inorganic oxide filler 21, solvent 22 and binder 23 are input into mixing tank 31 and dispersed and mixed to produce coating paint 25, and the viscosity of coating paint 25 is adjusted to, for example, 50 mPa·s in mixing tank 31 (S01). Specifically, for example, solvent 22 including N-methyl-2-pyrrolidone (NMP) and binder 23 including 4 parts by weight of PVDF (#1320, solid content 12 wt. %) produced by KUREHA CORPORATION are input into mixing tank 31, followed by adding 96 parts by weight of an inorganic oxide filler made of MgO. Then, they are dispersed and mixed by using dispersion blade 33 such as a disper and stirred by using stirring blade 35 such as an anchor. At this time, as the dispersion and mixing conditions, dispersing and mixing are carried out at the peripheral speed of the dispersion blade of 30 m/s; and as the stirring condition, stirring is carried out at the peripheral speed of the stirring blade of 3 m/s.

At this time, by optimizing the mixing ratio of the inorganic oxide filler, the binder, and the like, the viscosity of the dispersed and mixed coating paint is adjusted to 10 mPa·s or more and 3000 mPa·s or less. Above all, it is preferable that the viscosity is adjusted to 20 mPa·s or more and 100 mPa·s or less. This is because when the viscosity is less than 10 mPa·s, the coating property is bad and the composition changes easily, and on the other hand, when the viscosity is more than 3000 mPa·s, aggregates cannot easily precipitate and therefore the coating paint cannot be produced efficiently.

Next, dispersion blade 33 and stirring blade 35 are stopped, and dispersed and mixed coating paint 25 is allowed to stand still in mixing tank 31 and stored for, for example, several hours to about one day. The storage time is determined based on the productivity and the state of aggregates and it is not uniquely determined. When coating paint 25 is stored in a state in which it is allowed to stand still in this way, inorganic oxide fillers, which tend to aggregate with each other, are aggregated and precipitated as aggregates 27. Furthermore, coarse powders of the inorganic oxide filler, which are not dispersed and mixed, are precipitated as precipitates.

Aggregates 27 and precipitates of the inorganic oxide filler in coating paint 25, which are generated during still standing storage, are collected in collection portion 34 provided in the lower part of mixing tank 31 and removed (S02). At this time, in general, 1% to 2% of the inorganic oxide filler is removed from coating paint 25 as aggregates 27.

After aggregates and precipitates of the inorganic oxide filler are collected in the collection portion and removed, coating paint 25 is stored again in a state in which only stirring blade 35 is rotated.

Thus, by storing the coating paint in the convection state by using a stirring blade, aggregation of the inorganic oxide filler is not easily generated for a long time and a uniform coating paint with less composition change can be obtained.

Next, as shown in FIG. 4A, the coating paint from which aggregates and precipitates of the inorganic oxide filler have been removed in mixing tank 31 is supplied to coating solution pan 32 of gravure coater 30 including cylindrical (for example, diameter: 50 mm) gravure roll (cylinder) 36 and coating solution pan 32. The supplied coating paint is supplied to the surface of gravure roll 36 by rotating gravure roll 36 at the peripheral speed of, for example, 3 m/s.

Next, as shown in FIG. 4B, for example, long negative electrode precursor 26 including a current collector and a negative electrode mixture layer is sent and supplied onto gravure roll 36 to which coating paint 25 is supplied. Then, coating paint 25 is gravure-coated on the surface the negative electrode mixture layer (not shown) of one surface of long negative electrode precursor 26 via gravure roll 36 (S03). Specifically, gravure roll 36 of gravure coater 30 is immersed in coating solution pan 32 while it is rotated, thereby the coating paint is filled in a recess (not shown) of gravure roll 36. At the same time, the coating paint is adjusted to a predetermined thickness by using doctor blade 43. Negative electrode precursor 26, which is inserted between gravure roll 36 and roll 44 rotating at the opposite side of the gravure roll 36, is continuously sent. Thereby, coating paint 25 filled in the recess of gravure roll 36 is continuously transferred to the surface of the negative electrode mixture layer of negative electrode precursor 26 with a uniform thickness. In FIG. 4B, an example in which gravure roll 36 and roll 44 are rotated in one direction is described. However, the rotation direction is not limited to this alone and they may be rotated in any directions. Furthermore, the rotation direction may be reversed, and the coating paint may be transferred to the surface of the negative electrode mixture layer. Thus, the coating paint can be transferred to an arbitrary thickness.

Next, as shown in FIG. 2, the coated film is dried and hardened so as to form an insulating porous protective layer having a thickness of, for example, about 2 μm (S04). Similarly, although not shown, coating paint 25 is continuously coated on the surface of the negative electrode mixture layer formed on the other surface of negative electrode precursor 26, and then dried and hardened so as to form an insulating porous protective layer having a thickness of about 2 μm. Thus, negative electrode 1 is produced.

According to the first exemplary embodiment, since the dispersion blade, the stirring blade and collection portion 34 for collecting aggregates are provided in the same mixing tank 31, a uniformly dispersed and mixed coating paint can be produced at a low cost without using large scale circulation equipment and filtration equipment.

Furthermore, in accordance with the first exemplary embodiment, without carrying out circulation and filtration, the coating paint is allowed to stand still and stored so as to separate and remove aggregates 27 in advance by using only mixing tank 31 having dispersion blade 33 and stirring blade 35, and thereafter, the coating paint can be stored in a state in which inorganic oxide fillers are uniformly dispersed while it is stirred with stirring blade 35 again. As a result, it is possible to obtain a coating paint in which aggregates are not easily formed for a long time and the composition change over time is small.

Furthermore, with funnel-shaped portion 34a provided at the bottom of mixing tank 31, aggregates 27 and precipitates of the inorganic oxide filler can be collected in collection portion 34 provided at the tip of the funnel-shaped portion reliably. Furthermore, when collection portion 34 is provided at the tip of funnel-shaped portion 34a, precipitates, which have entered collection portion 34 once, can be prevented from floating in the coating paint again due to stirring by the stirring blade. As a result, it is possible to collect aggregates 27 and precipitates of the inorganic oxide filler easily and reliably.

Furthermore, according to the first exemplary embodiment, since course powders such as aggregates and precipitates of the inorganic oxide filler are removed in a dispersion device in advance, a coating streak, a grain, and the like, do not remain on the insulating porous protective layer formed on the negative electrode mixture layer. As a result, it is possible to produce a highly reliable negative electrode having a uniform and thin insulating porous protective layer with a uniform porosity in a high yield stably. Furthermore, in the secondary battery produced by using the above-mentioned negative electrode 1, a battery reaction is carried out uniformly. For example, the reliability such as a charge and discharge cycle characteristic and a heat resistance property can be improved remarkably.

Note here that collection portion 34 may be provided detachably with respect to mixing tank 31, for example, provided in a cartridge form. Thus, aggregates and precipitates entering collection portion 34 can be discarded on a regular basis or continuously without interrupting dispersing and mixing. Therefore, it is possible to produce a highly reliable negative electrode having an insulating porous protective layer by using a coating paint whose composition change over time is small and which has a stable quality in a high yield.

Herein, as inorganic oxide filler 21, powder of an inorganic oxide including at least one of alumina, magnesia, silica, zirconia and titania or a complex oxide thereof, and the like, can be used. The shape of the inorganic oxide filler is not particularly limited. Furthermore, these can be used singly or in combination of two or more kinds of them.

Furthermore, an example of binder 23 may include, for example, PVDF, polytetrafluoroethylene, polyethylene, polypropylene, aramid resin, polyamide, polyimide, polyamide-imide, polyacrylonitrile, polyacrylic acid, polymethylacrylate ester, polyethylacrylate ester, polyhexylacrylate ester, polymethacrylic acid, polymethylmethacrylate ester, polyethylmethacrylate ester, polyhexylmethacrylate ester, polyvinylacetate, polyvinylpyrrolidone, polyether, polyethersulfone, hexafluoropolypropylene, styrene-butadiene rubber, carboxymethylcellulose, and the like. Furthermore, a copolymer of two or more kinds of materials selected from tetrafluoroethylene, hexafluoroethylene, hexafluoropropylene, perfluoro-alkylvinyl ether, vinylidenefluoride, chlorotrifluoroethylene, ethylene, propylene, pentafluoropropylene, fluoromethylvinyl ether, acrylic acid, hexadiene, may be used. Furthermore, a mixture including two or more of them may be used.

Then, as solvent 22, a nonaqueous solvent such as N-methyl-2-pyrrolidone (NMP) is used.

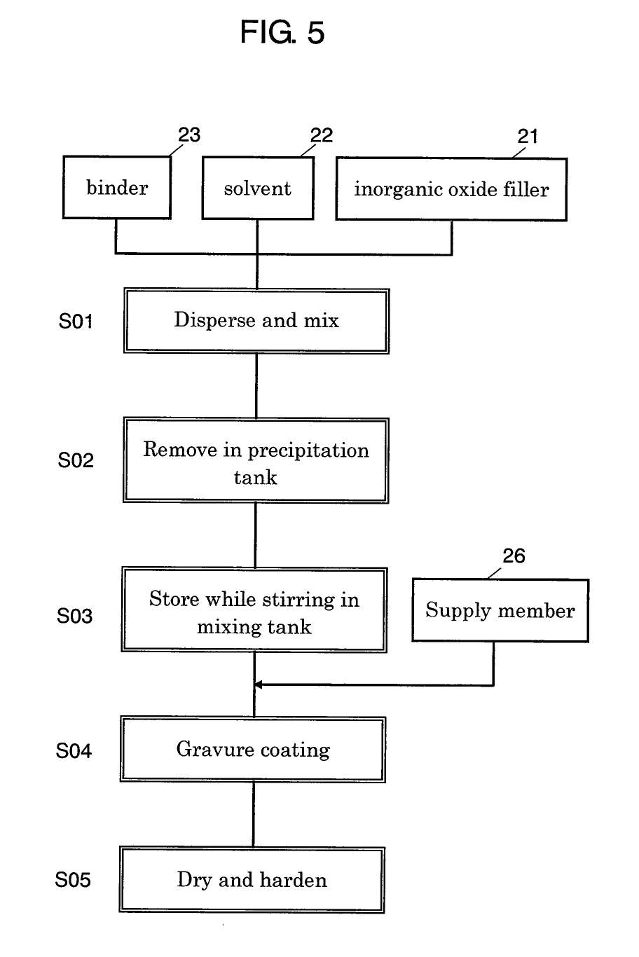

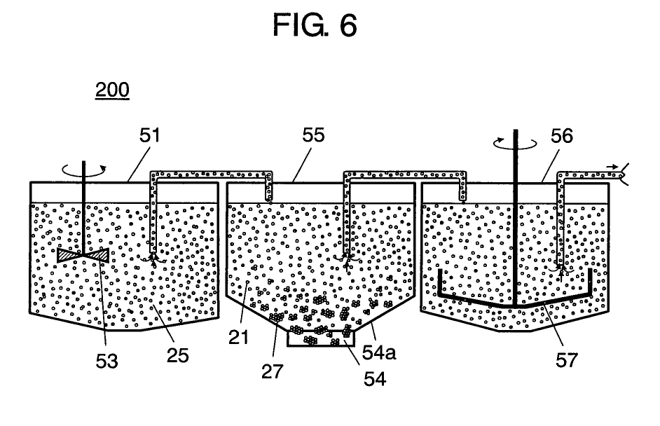

Hereinafter, another example of the method for manufacturing a member for a secondary battery in accordance with the exemplary embodiment of the present invention is described with reference to FIGS. 5 and 6.

FIG. 5 is a flowchart showing another example of a method for manufacturing a member for a secondary battery in accordance with the first exemplary embodiment of the present invention.

FIG. 6 is a conceptual sectional view showing another configuration of a dispersion device of the apparatus for manufacturing a member for a secondary battery in accordance with the first exemplary embodiment of the present invention.

That is to say, FIG. 5 is different from FIG. 2 in that aggregates and precipitates of the inorganic oxide filler are removed in a precipitation tank. Furthermore, FIG. 6 is different from FIG. 3 in that FIG. 6 includes precipitation tank 55 in which coating paint 25 that has been dispersed and mixed in mixing tank 51 of dispersion device 200 are input and allowed to stand still and aggregates and precipitates of the inorganic oxide filler are removed, and storage tank 56 for storing the coating paint, from which aggregates and precipitates have been removed, while stirring with blade 57. Then, at least precipitation tank 55 has funnel-shaped portion 54a formed on the bottom thereof and collection portion 54 provided on the lower part of funnel-shaped portion 54a.

Firstly, as shown in FIGS. 5 and 6, at least inorganic oxide filler 21, solvent 22 and binder 23 are input into mixing tank 51 and dispersed and mixed to prepare coating paint 25, and the viscosity of coating paint 25 is adjusted to, for example, 80 mPa·s in mixing tank 51 (S01). Specifically, for example, solvent 22 including N-methyl-2-pyrrolidone (NMP) and binder 23 including 4 parts by weight of PVDF (#1320, solid content 12 wt. %) produced by KUREHA CORPORATION are input into mixing tank 51, followed by adding an inorganic oxide filler made of 96 parts by weight of Al₂O₃. Then, they are dispersed and mixed by using dispersion blade 53 such as a disper provided in mixing tank 51. At this time, dispersing and mixing are carried out at the peripheral speed of dispersion blade 53 of 30 m/s.

Next, coating paint 25 dispersed and mixed in mixing tank 51 is input into precipitation tank 55 and allowed to stand still for, for example, several hours to about one day. When coating paint 25 is allowed to stand still in this way, inorganic oxide fillers, which tend to aggregate with each other, are aggregated and precipitated as aggregates 27. Furthermore, coarse powders of the inorganic oxide filler, which are not dispersed and mixed, are precipitated as precipitates.

Then, aggregates 27 and precipitates of the inorganic oxide filler in coating paint 25, which are generated while the coating paint is allowed to stand still and stored, are collected in collection portion 54 provided in the lower part of precipitation tank 55 and removed (S02). At this time, in general, 1% to 2% of the inorganic oxide filler is removed from coating paint 25 as aggregates 27.

Next, coating paint 25, from which aggregates and precipitates of the inorganic oxide filler have been removed after being collected in collection portion 54, is input into storage tank 56 having stirring blade 57 such as an anchor. Coating paint 25 is stored or conserved in the precipitation tank in a state in which stirring blade 57 is rotated (S03). Stirring at this time is carried out at the peripheral speed of stirring blade 57 of 3 m/s as the stirring condition.

Next, as described with reference to FIGS. 4A and 4B, a coating paint supplied from storage tank 56 is input into coating solution pan 32 of gravure coater 30. Then, long negative electrode precursor 26 including a current collector and a negative electrode mixture layer is sent onto gravure roll 36 to which coating paint 25 is supplied. Gravure coating is carried out on one surface of the negative electrode mixture layer (not shown) (S04).

Next, as shown in FIG. 5, the coated film is dried and hardened so as to form an insulating porous protective layer having a thickness of, for example, about 2 μm. Thus, negative electrode 1 is produced (S05).

Note here that since the specific method is the same as mentioned above, description therefor is omitted.

In accordance with another example of the first exemplary embodiment, since the coating paint is stored while it is stirred with a stirring blade of a storage tank, aggregates of the inorganic oxide filler is not easily generated for a long time and thus a uniform coating paint with less composition change can be obtained.

Furthermore, since a precipitation tank is not provided with a stirring blade or a dispersion blade, it is possible to prevent aggregates from floating again due to convection and the like. In other words, by providing a mixing tank, a precipitation tank and a storage tank independently, for example, even when an inexpensive inorganic oxide filler including many coarse powders is used, sufficient dispersing and mixing can be carried out in the mixing tank by setting the dispersion condition to be strong. Furthermore, since aggregates and the like do not float again, it is easy to set the stirring condition in a storage tank. As a result, by using a manufacturing apparatus having a wide adjustment range, a stable coating paint in which aggregates are not easily generated for a long time and composition change is small over time can be obtained.

Furthermore, with funnel-shaped portion 54a provided at the bottom of precipitation tank 55, aggregates 27 and precipitates of the inorganic oxide filler can be collected in collection portion 54 provided at the tip of the funnel-shaped portion reliably.

Furthermore, since coarse powders such as aggregates and precipitates of the inorganic oxide filler are removed in a dispersion device in advance, generation of a coating streak and remaining of a grain and the like are not observed on the negative electrode mixture layer. As a result, it is possible to produce a highly reliable negative electrode having a thin and uniform insulating porous protective layer with a uniform porosity in a high yield and stably. Furthermore, in the secondary battery produced by using the above-mentioned negative electrode 1, a battery reaction is carried out uniformly. For example, a charge and discharge cycle characteristic and the reliability such as a heat resistance property can be improved remarkably.

Furthermore, collection portion 54 may be detachably provided to precipitation tank 55, for example, provided in a cartridge form. Thus, precipitates entering collection portion 54 can be discarded on a regular basis or continuously without interrupting dispersing and mixing. Therefore, it is possible to produce highly reliable negative electrode having an insulating porous protective layer by using a coating paint whose composition change over time is small and which has a stable quality in a high yield.

Note here that in the above-mentioned example, an example in which a stirring blade is provided in a storage tank is described. However, the configuration is not limited to this alone. For example, a stirring blade is provided in a precipitation tank, and an inorganic oxide filler input into the precipitation tank is allowed to stand still and stored so as to collect aggregates in advance, and then the inorganic oxide filler may be stored or conserved in the precipitation tank in a state in which the stirring blade is rotated. Thus, a storage tank can be omitted and the size of the manufacturing apparatus can be made smaller.

Furthermore, in the above description, an example in which a stirring blade is provided in only a storage tank is described. However, the configuration is not limited to this alone. The stirring blade may be provided in a mixing tank. Thus, the mixture can be dispersed and mixed efficiently. At this time, when the convection of the mixture is generated with the dispersion blade shown in the above-mentioned exemplary embodiment, a stirring blade is not necessarily provided.

Furthermore, in the above description, an example in which a collection portion is provided in a precipitation tank is described. However, the configuration is not limited to this alone and the collection portion may be provided in a mixing tank or a storage tank. Thus, aggregates are collected more reliably, and a negative electrode as a member for a secondary battery that is excellent in the reliability can be produced by using a stable coating paint whose composition change is small for a long time.

In the first exemplary embodiment, an example in which an insulating porous protective layer is formed on the surface of the negative electrode is described. However, the configuration is not limited to this alone. For example, an insulating porous protective layer may be formed by coating on any one of a positive electrode or a separator.

Thus, by producing a positive electrode, a negative electrode or a separator having a thin insulating porous protective layer with a uniform composition by using a coating paint that is free from aggregates and has small composition change, a secondary battery that is excellent in the safety and the reliability can be manufactured with a high productivity and at a low cost.

Hereinafter, specific Examples in accordance with the first exemplary embodiment of the present invention are described. Furthermore, in the below-mentioned Examples, a coating paint produced by using a manufacturing apparatus in which a precipitation tank is provided individually is described. However, the same is true in a coating paint produced in a configuration having only a mixing tank.

In each Example, the coating paint is coated on the surface of a negative electrode mixture layer, having a thickness of about 25 μm, of the negative electrode, and evaluation is carried out.

### Example 1

Firstly, 100 parts by weight of artificial graphite, 1.5 parts by weight of denatured styrene-butadiene rubber (SBR) including 40 wt. % of solid content and 1.0 part by weight of carboxymethyl cellulose (CMC) are stirred together with an appropriate amount of water in a double arm kneader so as to prepare a negative electrode mixture paste. This negative electrode mixture paste is applied onto the both surfaces of a copper foil as a current collector, having a thickness of about 12 μm, of the negative electrode and dried, followed by rolling a negative electrode mixture layer so that the total thickness becomes 160 μm. Thus, a negative electrode precursor is produced.

Next, N-methyl-2-pyrrolidone (NMP) as a solvent and 4 parts by weight of polyvinylidene fluoride (PVDF) as a binder are input into a mixing tank and stirred at the peripheral speed of 30 m/s.

Next, to this stirred product, as an inorganic oxide filler, 96 parts by weight of MgO (magnesia) having an average particle diameter D50 of 0.98 μm is added in a mixing tank so that the viscosity of the coating paint becomes 50 mPa·s. Then, by rotating the dispersion blade at the peripheral speed of 30 m/s for ten minutes in a state in which MgO is added, the coating paint is dispersed and mixed, and adjustment is carried out. The viscosity is a value measured at the shear rate of 100 m/s by using a rheometer.

Next, the mixed and dispersed coating paint is input into a precipitation tank and allowed to stand still and stored for 24 hours in this state. Then, during still standing storage, aggregates of MgO aggregated to the size of about 5 μm to 50 μm and coarse powders are allowed to precipitate and separate, and then collected in a collection portion. Note here that at the time of dispersing and mixing and at the time of still standing storage, circulation and filtration of the coating paint are not carried out. At this time, if necessary, the collection portion provided in the lower part of the precipitation tank is taken off, and the aggregated and precipitated MgO is removed.

Next, the coating paint, from which aggregates and coarse powders have been removed, is input into a storage tank and stored therein while a stirring blade is rotated at the peripheral speed of 3 m/s.

Next, after aggregates and precipitates are removed, gravure roll (cylinder) 36 having a diameter of, for example, 50 mm is rotated at the rotation number corresponding to, for example, the peripheral speed of 3 m/s and the coating paint in a coating solution pan is supplied onto the surface of the gravure roll.

Next, the negative electrode precursor formed as mentioned above is sent and supplied onto the gravure roll. Then, the coating paint filled in a recess of the gravure roll is continuously coated onto at least one surface of the negative electrode mixture layer of the negative electrode precursor.

After the coating paint is coated, it is dried and hardened so as to form an insulating porous protective layer having a thickness of about 2 μm on the negative electrode mixture layer. In addition, an insulating porous protective layer is formed also on the other surface of the negative electrode precursor by a similar method. Thus, a negative electrode is produced.

The negative electrode produced by the above-mentioned method and a battery produced by using the negative electrode by a production method mentioned below are defined as sample 1.

### Examples 2 to 5

In each of Examples 2 to 5, a negative electrode as a member for a secondary battery is produced respectively in the same manner as in Example 1 except that α-Al₂O₃ (alumina) having an average particle diameter D50 of 0.7 μm, anatase-TiO₂ (titania) having D50 of 0.7 μm, SiO₂ (silica) having D50 of 0.7 μm, and ZrO₂ (zirconia) having D50 of 0.9 μm are used as an inorganic oxide filler respectively. At this time, each viscosity of the coating paint is 42 mPa·s, 48 mPa·s, 40 mPa·s and 38 mPa·s.

The negative electrodes of samples produced in this way are defined as samples 2 to 5, respectively.

### Examples 6 to 11

In each of Examples 6 to 11, a negative electrode is produced in the same manner as in Example 1 except that the viscosity of the coating paint is set to 10 mPa·s, 112 mPa·s, 524 mPa·s, 987 mPa·s, 1892 mPa·s and 3000 mPa·s, respectively. Then, the obtained negative electrodes are defined as samples 6 to 11, respectively.

### Comparative Examples 1 and 2

As Comparative Examples 1 and 2, a negative electrode is produced in the same manner as in Example 1 except that the viscosity of the coating paint is set to 9 mPa·s and 3382 mPa·s. These are defined as samples C1 and C2, respectively.

### Comparative Example 3

A negative electrode is produced in the same manner as in Example 1 except that a coating paint is produced by a method of circulating the coating paint and filtering aggregates instead of a method of precipitating and separating aggregates in advance. This negative electrode is defined as sample C3.

### Comparative Examples 4 to 6

In each of Comparative Examples 4 to 6, a negative electrode is produced in the same manner as in Example 1 except that the viscosity of the coating paint is set to 121 mPa·s, 502 mPa·s and 1016 mPa·s and that a coating paint is produced by the method of circulating the coating paint and filtering aggregates instead of the method of precipitating and separating aggregates in advance. These are defined as samples C4 to C6.

The coating paints produced as mentioned above are evaluated based on the paint stability and coating defects mentioned below.

Firstly, the solid content change rate generated while the coating paint is stored is measured. By using this change rate, “paint stability” is evaluated from the stability of the dispersion state of the coating paint based on the below mentioned standard.

∘: 1% or less, ▴: 1% to 2%, x: 2% or more

Note here that the solid content change rate is measured by the following method.

Firstly, the dispersed and mixed coating paint is taken into a tube having a height of 10 cm and diameter of 1 cm, and allowed to stand still and stored for 7 days in this state.

Next, the tube is cut out in the position 1 cm from the bottom of the tube, the coating paint is collected. Then, the ratio of a solid content formed therein is measured.

Furthermore, the coating paint is coated on the surface of the negative electrode mixture layer of the negative electrode by using a gravure printing method and dried so as to form a coated film of an insulating porous protective layer having a thickness of about 5 μm. The negative electrode having the insulating porous protective layer formed by coating on the surface thereof is cut in a shape with the size of 50×500 mm. The surface of the porous protective layer is observed, and evaluated for “coating defect” based on the evaluation standard mentioned below.

∘: coating streak and grain are not observed,

▴: coating streak having a width of 1 mm or less and grain are observed

x: coating streak having a width of 1 mm or more and grain are observed

The parameters and evaluation results of samples 1 to 11 and samples C1 to C6 are shown in Table 1.

TABLE 1

| | Parameter | | | | | | Evaluation | |
|---|---|---|---|---|---|---|---|---|
| | Inorganic | Particle | | | | | results | |
| | oxide | diameter | Viscosity | | | | Paint | Coating |
| *1 | filler | D50 (μm) | (mPa · s) | (1) | (2) | (3) | stability | defect |
| Sample 1 | MgO | 0.98 | 50 | Y | Y | N | ∘ | ∘ |
| Sample 2 | α-Al₂O₃ | 0.7 | 42 | Y | Y | N | ∘ | ∘ |
| Sample 3 | anatase- | 0.7 | 48 | Y | Y | N | ∘ | ∘ |
| | TiO₂ | | | | | | | |
| Sample 4 | SiO₂ | 0.7 | 40 | Y | Y | N | ∘ | ∘ |
| Sample 5 | ZrO₂ | 0.9 | 38 | Y | Y | N | ∘ | ∘ |
| Sample 6 | MgO | 0.98 | 10 | Y | Y | N | ∘ | ∘ |
| Sample 7 | MgO | 0.98 | 112 | Y | Y | N | ∘ | ∘ |
| Sample 8 | MgO | 0.98 | 524 | Y | Y | N | ∘ | ∘ |
| Sample 9 | MgO | 0.98 | 987 | Y | Y | N | ∘ | ∘ |
| Sample 10 | MgO | 0.98 | 1892 | Y | Y | N | ∘ | ∘ |
| Sample 11 | MgO | 0.98 | 3000 | Y | Y | N | ∘ | ∘ |
| Sample C1 | MgO | 0.98 | 9 | Y | Y | N | ▴ | ▴ |
| Sample C2 | MgO | 0.98 | 3382 | Y | Y | N | ▴ | ▴ |
| Sample C3 | MgO | 0.98 | 50 | N | Y | Y | x | x |
| Sample C4 | MgO | 0.98 | 121 | N | Y | Y | x | x |
| Sample C5 | MgO | 0.98 | 502 | N | Y | Y | x | x |
| Sample C6 | MgO | 0.98 | 1016 | N | Y | Y | x | x |

(1) Separation in precipitation tank is carried out (Y) or not carried out (N)
(2) Stirring is carried out (Y) or not carried out (N)
(3) Circulation is carried out (Y) or not carried out (N)

As is apparent from Table 1, in samples 1 to 5, the negative electrodes produced by the manufacturing method in accordance with the first exemplary embodiment are excellent in the paint stability and free from coating defect regardless of the material of inorganic oxide filler. This is because aggregates of the inorganic oxide filler can be removed efficiently in the collection portion of the precipitation tank and because aggregates larger than the film thickness are not generated due to the stirring blade of the storage tank.

Furthermore, in samples 6 to 11 and samples C1 to C2, when the viscosity of the coating paint is in the range from 10 mPa·s to 3000 mPa·s, a porous protective layer that is excellent in the paint stability and free from coating defect can be formed. This is because aggregates of inorganic oxide filler are removed efficiently in this viscosity range.

On the other hand, in sample C1 having a viscosity of less than 10 mPa·s or sample C2 having a viscosity of more than 3000 mPa·s, the solid content change rate is 1% to 2% and the paint stability is reduced due to the aggregates thereof and the like. Furthermore, in the porous protective layers thereof, coating defects such as a coating streak having a width of 1 mm or less and a grain are generated. The reason for this can be thought as follows. In the case of sample C1 having a viscosity of less than 10 mPa·s, since the viscosity is too low, aggregates are easily generated even when the stirring speed is increased, so that the composition change is large. Furthermore, in sample C2 having a viscosity of more than 3000 mPa·s, although aggregation itself does not easily occur, when aggregation occurs, aggregates are not easily precipitated but remain in the coating paint. Furthermore, since coarse powders are also not easily precipitated, the uniformity of the coating paint is reduced.

Furthermore, sample 1 is compared with samples C3 to C6. Even when the viscosity of the coating paint is in the optimal range, if precipitation and separation are not carried out, the solid content change rate is 2% or more even when circulation and filtration are carried out. Therefore, a coating streak having a width of 1 mm or more and a grain are generated. This is thought to be because in a case where the coating paint is produced only by circulation and filtration without carrying out precipitation and separation, when the coating paint comes out from the circulation line and returns to the mixing tank again, reaggregation of inorganic oxide filler occurs.

Hereinafter, the property of a secondary battery produced by using the negative electrode of sample 1 is evaluated. Note here that the secondary battery is produced by the following method.

Firstly, Li₂CO₃ and CO₃O₄ are mixed and the mixture is fired at 900° C. for 10 hours so as to obtain LiCoO₂ as a positive electrode active material, followed by grinding and classifying thereof. Thus, lithium-containing complex oxide powders having an average particle diameter of 12 μm are produced. Then, 100 parts by weight of this lithium-containing complex oxide is stirred together with 50 parts by weight of PVDF (NMP solution containing 12 wt. % of solid content), 4 parts by weight of acetylene black and an appropriate amount of NMP in a double arm kneader at 30° C. for 30 minutes so as to prepare a positive electrode mixture paste. This paste is applied on both surfaces of 20 μm thick-aluminum foil that works as current collector 14, dried at 120° C. for 15 minutes, and roll pressed so that the total thickness becomes 160 μm. Thereafter, it is cut by a slitter so as to have a width capable of being inserted into round-shaped case 5 having a diameter of 18 mm and height of 65 mm. A part of the positive electrode mixture layer is peeled off and a lead is coupled to the current collector.

Next, 100 parts by weight of artificial graphite, 7 parts by weight of dispersing solution of denatured styrene-butadiene rubber (SBR) including 40 wt. % of solid content and 1.6 parts by weight of carboxymethyl cellulose (CMC) are stirred with an appropriate amount of water in a double arm kneader so as to prepare a negative electrode mixture paste. This negative electrode mixture paste is applied onto the both surfaces of a copper foil as a current collector, having a thickness of about 12 μm, of the negative electrode, dried, and rolled so that the total thickness becomes 160 μm. Thereafter, it is cut by a slitter so as to have a width capable of being inserted into case 5 having a diameter of 18 mm and height of 65 mm. Thus, negative electrode is produced. A part of the positive electrode mixture layer is peeled off and a lead is coupled to the current collector.

The positive electrode produced as mentioned above and the negative electrode of sample 1 are wound with a separator interposed therebetween so as to form a coiled electrode group.

Thereafter, the electrode group is inserted into the case, and a sealing plate provided with an insulating gasket on the periphery thereof and lead 8 are made to be conducting. On the other hand, the case and the other lead are made to be conducting. An electrolyte solution is filled in the case and the opening of the case is sealed with the sealing plate. As the electrolyte solution, a solution of LiPF₆ dissolved in a mixture solvent of EC:EMC (weight ratio of 1:3) at the concentration of 1 mol/litter is used. The battery produced in this way is charged and discharged at constant current of 100 mA and at charging stopping voltage of 4.2V and discharging stopping voltage of 3.0V three times repeatedly. Thus, a round-shaped secondary battery with the size of diameter of 18 mm and height of 65 mm is produced. The design capacity of the battery is set to 2600 mAh. This is defined as sample battery 1.

Furthermore, for comparison, a secondary battery is produced in the same manner as mentioned above except that the negative electrode of sample C3 is used. This is defined as sample battery C1.

The battery produced as mentioned above is subjected to a charging and discharging cycle test, in which the battery is charged at environmental temperature of 25° C. at constant voltage of 4.2V (maximum electric current: 1000 mA and minimum electric current: 100 mA), 30 minutes later, discharged at constant current of 200 mA until the end voltage of 3.0 V, and this charging and discharging is repeated 500 times.

Furthermore, in order to evaluate the safety, an overcharge test is carried out by the below-mentioned method. In a thermostat bath whose temperature is controlled to 25° C., charging is started at 12V constant voltage charging (maximum electric current: 1000 mA) and current carrying is stopped when the battery temperature reached 105° C. At this time, the battery temperature in the center of the battery is recorded for 30 minutes after the test and the maximum temperatures of batteries are compared with each other.

As a result, in sample battery 1, the ratio of the discharge capacity after 300 cycles of charging and discharging with respect to the initial discharge capacity is 80% or more. On the other hand, in sample battery C1, the ratio is 50% to 85%, showing that the variation is large and the discharge capacity is remarkably reduced. This is thought to be because aggregates and coarse powders of the inorganic oxide filler are removed and an insulating porous protective layer is formed, thereby the battery reaction becomes uniform and a secondary battery with less variation can be produced.

Furthermore, in the overcharge test, in sample battery C1 as compared with battery 1, the temperature rise is larger and the variation thereof is also larger. This is thought to be because the direct contact between the positive electrode and the negative electrode is prevented in the overcharge test by the uniformly formed porous protective layer having a heat resistance property and an insulating property.

As mentioned above, when a insulating porous protective layer having a uniform thickness and homogeneous composition is formed on a separator by using a coating paint for a secondary battery which is free from aggregates and has a stable composition ratio, a secondary battery having an improved safety and battery property reliability can be produced. Furthermore, in a secondary battery in which the insulating porous protective layer is similarly formed by using each of the negative electrodes of other samples 2 to 11, the reliability and the safety are similarly improved.

### Second Exemplary Embodiment

A second exemplary embodiment of the present invention is different from the first exemplary embodiment in that removing of aggregates and precipitates of an inorganic oxide filler is carried out in a mixing tank and a precipitation tank of a dispersion device in the first exemplary embodiment but is carried out in a precipitation tank that is a coating solution pan of gravure coater 30 in the second exemplary embodiment. Note here that the description of the same configuration and the production method of a secondary battery as those of the first exemplary embodiment are omitted herein.

In a method for manufacturing a member for a secondary battery in accordance with the second exemplary embodiment of the present invention, firstly, at least an inorganic oxide filler, a solvent and a binder are dispersed and mixed; then, a coating paint is allowed to stand still and stored in a coating solution pan that is a precipitation tank of a gravure coater; and aggregates and precipitates of the inorganic oxide filler are removed. Thereafter, the coating paint is gravure printed so as to form an insulating porous protective layer on the surface of negative electrode mixture layer 13 of negative electrode 1, and thus, a negative electrode as a member for a secondary battery is produced.

Then, as shown in FIG. 1, negative electrode 1 provided with an insulating porous protective layer and positive electrode 2 are wound with separator 3 interposed therebetween so as to realize a secondary battery that is excellent in the safety and the reliability such as a heat resistance property.

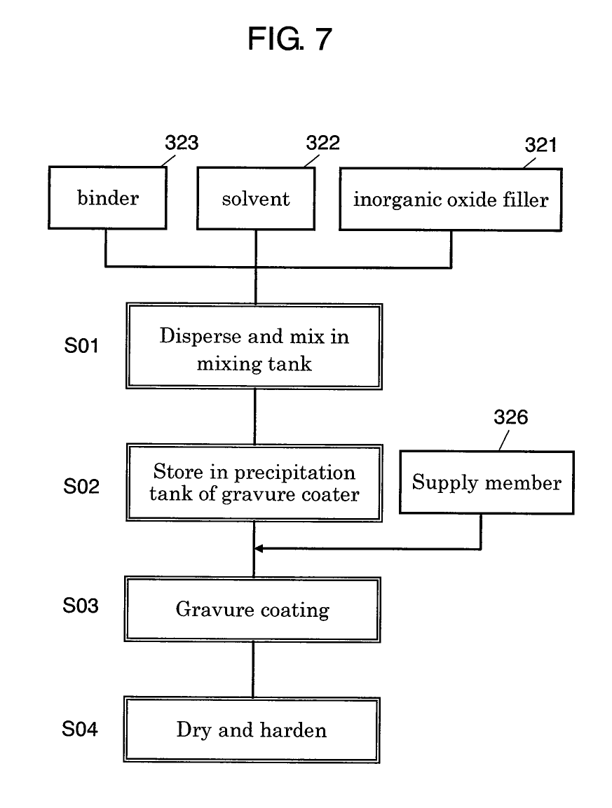

Hereinafter, a method for manufacturing a member for a secondary battery provided with an insulating porous protective layer is described with reference to FIGS. 7, 8A, 8B and 9.

FIG. 7 is a flowchart showing a method for manufacturing a member for a secondary battery in accordance with the second exemplary embodiment of the present invention.

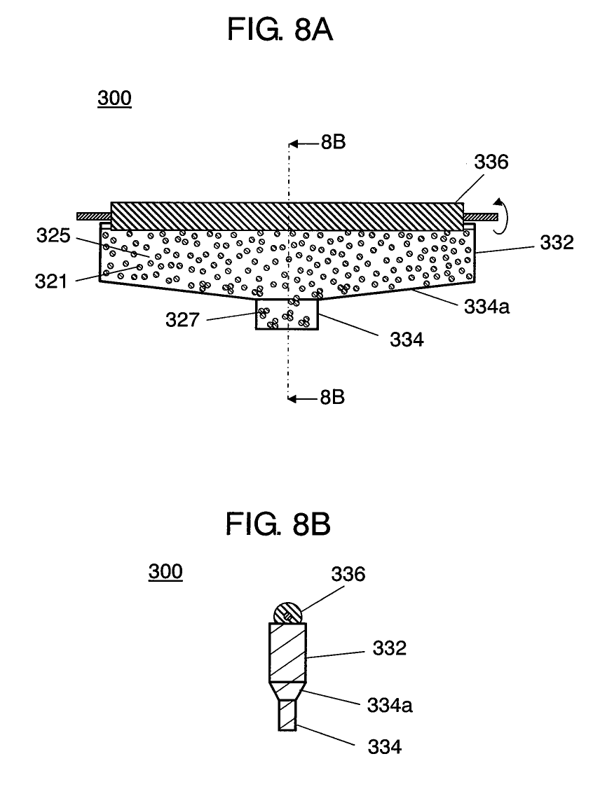

FIG. 8A is a conceptual sectional view showing a gravure coater of an apparatus for manufacturing a member for a secondary battery in accordance with the second exemplary embodiment of the present invention; and FIG. 8B is a conceptual sectional view taken along line 8B-8B of FIG. 8A.

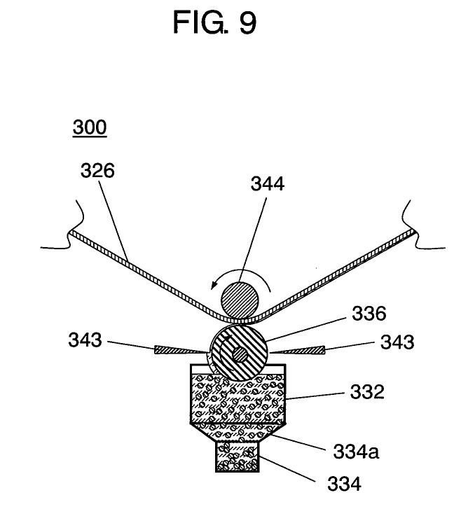

FIG. 9 is a conceptual sectional view showing a process and the apparatus for manufacturing a member for a secondary battery in accordance with the second exemplary embodiment of the present invention.

Firstly, as shown in FIG. 7, for example, at least inorganic oxide filler 321, solvent 322 and binder 323 are input into a dispersion device (not shown) and they are dispersed and mixed so as to obtain coating paint 325 as the mixture, and the viscosity thereof is adjusted to, for example, 50 mPa·s in the dispersion device (S01). Since the specific method, adjustment range of the viscosity, and the like, are the same as those of the first exemplary embodiment, the description therefore is omitted herein.

Next, as shown in FIGS. 7, 8A and 8B, coating paint 325 dispersed and mixed in the dispersion device is supplied into precipitation tank 332 that also works as a coating solution pan of gravure coater 300, allowed to stand still and stored for, for example, several hour to one day. Note here that the storage time is determined by considering the productivity and the state of aggregates, and it is not determined uniquely. When the coating paint is stored in a still standing state in this way, coarse powders and aggregates of the inorganic oxide filler, which are not dispersed and mixed, are precipitated as precipitates. Furthermore, inorganic oxide fillers that tend to aggregate with each other are aggregated and precipitated as aggregate 327.

Before carrying out gravure printing, precipitates such as aggregates 327 and coarse powders of the inorganic oxide filler in coating paint 325, which are precipitated during still standing storage in precipitation tank 332, are removed from funnel-shaped portion 334a and collection portion 334 provided in the lower part of precipitation tank 332 (S02). At this time, in general, 1% to 2% of inorganic oxide filler is removed as aggregate 327 from coating paint 325.

Next, as shown in FIGS. 8A and 8B, after aggregates and precipitates are removed in precipitation tank 332, by rotating cylindrical (for example, diameter of 50 mm) gravure roll (cylinder) 336 at the rotation number corresponding to, for example, the peripheral speed of 3 m/s so that coating paint 325 is stirred. With this rotation of gravure roll 336, coating paint 325 is stirred slowly. Then, it is possible to prevent reaggregation over time of an inorganic oxide filler.

Next, as shown in FIGS. 7 and 9, gravure roll 336 is rotated in precipitation tank 332 that is a coating solution pan of gravure coater 300, and coating paint 325 is stirred and at the same time, it is supplied to the surface of the gravure roll. Thus, with the rotation of gravure roll 336, coating paint 325 is prevented from being reaggregated and stably supplied to the surface of gravure roll 336 while it is uniformly dispersed.

Then, for example, long negative electrode precursor 326 including a current collector and a negative electrode mixture layer is sent out and supplied onto gravure roll 336 to which coating paint 325 is supplied.

Furthermore, coating paint 325 is gravure coated on one surface of the negative electrode mixture layer (not shown) of long negative electrode precursor 326 via gravure roll 336 (S03). Specifically, gravure roll 336 of gravure coater 300 is immersed in precipitation tank 332 and rotated, thereby the coating paint is filled in a recess (not shown) of gravure roll 336. At the same time, the coating paint is adjusted to have a predetermined thickness by using doctor blade 343. Negative electrode precursor 326, which is inserted between gravure roll 336 and roll 344 rotating at the opposite side of the gravure roll 36, is continuously sent. Thereby, the coating paint filled in the recess of gravure roll 336 is continuously transferred to the surface of the negative electrode mixture layer of negative electrode precursor 326 with a uniform thickness. In FIG. 9, an example in which gravure roll 336 and roll 344 are rotated in one direction is described. However, the rotation direction is not limited to this alone and they may be rotated in any directions. Furthermore, the rotation direction may be reversed, and the coating paint may be transferred to the surface of the negative electrode mixture layer. Thus, the coating paint can be transferred to an arbitrary thickness.

Next, as shown in FIG. 7, the coated film is dried and hardened so as to form an insulating porous protective layer having a thickness of, for example, about 2 μm (S04). Similarly, although not shown, coating paint 325 is continuously coated on the surface of the negative electrode mixture layer formed on the other surface side of negative electrode precursor 326, and then dried and hardened so as to form an insulating porous protective layer having a thickness of about 2 μm. Thus, negative electrode 1 is produced.

According to the above-mentioned method, the coating paint is allowed to stand still and stored in the precipitation tank, and aggregates and precipitates are removed. Thereby, it is possible to obtain a coating paint having a stable composition and being free from aggregates and the like when gravure coating is carried out. Then, when this coating paint is used and stirred with a gravure roll, the generation of aggregates is prevented and a thin insulating porous protective layer that is free from a coating streak and a grain can be formed on the negative electrode precursor.

Furthermore, in a secondary battery produced by using a negative electrode as a member for a secondary battery provided with an insulating porous protective layer, a battery reaction can be carried out uniformly. For example, a charge and discharge cycle characteristic and the reliability such as a heat resistance property can be improved remarkably.

According to the second exemplary embodiment, by removing aggregates and precipitates while the coating paint is allowed to stand still and stored in a precipitation tank (coating solution pan) before gravure coating, a member for a secondary battery provided with an insulating porous protective layer free from defects such as a coating streak can be produced efficiently by gravure printing. Furthermore, in the coating paint, since aggregates and precipitates of the inorganic oxide filler are removed and composition change is reduced, a uniform porous protective layer having a stable film porosity can be formed. As a result, a member for a secondary battery having an insulating porous protective layer with a uniform thickness and homogeneity on the surface by an easy method using a gravure printing method can be manufactured stably in a high yield and at a low cost.

Furthermore, after aggregates are precipitates are removed, the coating paint is stirred by the rotation of the gravure roll. Thereby, it is possible to prevent the inorganic oxide filler from being reaggregated over time.

Furthermore, since right before the insulating porous protective layer is formed, the generation of aggregates can be suppressed, for example, it is possible to form a film to the thickness of about 2 μm, which has been conventionally about 5 μm. Consequently, the number of winding of a member of a secondary battery is increased, thus making it possible to realize a secondary battery having a large battery capacity.

Herein, as shown in FIGS. 8A, 8B and 9, an apparatus for manufacturing a member for a secondary battery includes a dispersion device (not shown) for dispersing and mixing coating paint 325 including inorganic oxide filler 321, solvent 322 and binder 323; and a gravure coater provided with precipitation tank 332 (coating solution pan) having funnel-shaped portion 334a at the bottom and a gravure roll. In the lower part of funnel-shaped portion 334a of precipitation tank 332, collection portion 334 for collecting precipitates such as aggregates 327 and coarse powders of the inorganic oxide filler is provided.

By using the above-mentioned manufacturing method, firstly, coating paint 325 dispersed and mixed in the dispersion device is allowed to stand still and stored in precipitation tank 332, and large coarse powders and aggregates are removed. Next, the coating paint is stirred by the rotation of the gravure roll so as to prevent reaggregation without carrying out circulation and filtration.

Thus, without adding a large circulation equipment or filtration equipment to a manufacturing apparatus, a manufacturing apparatus capable of manufacturing a small and inexpensive member for a secondary battery can be produced.

Furthermore, with funnel-shaped portion 334a provided at the bottom of precipitation tank 332, large coarse powders and aggregates as well as aggregates 327 of the inorganic oxide filler generated during a long-time storage can be collected reliably in collection portion 334 provided at the tip of the funnel portion. In addition, by providing collection portion 334 at the tip of funnel-shaped portion 334a, precipitates entering collection portion 334 once can be prevented from floating into the coating paint again. As a result, aggregates 327 and precipitates of the inorganic oxide filler can be collected easily and reliably.

Note here that collection portion 334 may be provided detachably with respect to precipitation tank 332, for example, provided in a cartridge form. Thus, aggregates and precipitates collected in collection portion 334 can be collected and discarded on a regular basis or continuously repeatedly.

Furthermore, in the second exemplary embodiment, an example in which a stirring blade and a dispersion blade are provided in a dispersion device is described. However, in the case where convection occurs by only a dispersion blade, a stirring blade is not particularly necessary. Dispersing and mixing can be carried out by only a dispersion blade.

Furthermore, in the second exemplary embodiment, an example in which an insulating porous protective layer is formed on the surface of a negative electrode mixture layer of the negative electrode is described. However, the configuration is not limited to this alone. For example, an insulating porous protective layer may be coated and formed on any one of the positive electrode and the separator. Thus, similar to the case of the negative electrode, it is possible to realize a secondary battery being excellent in the safety and the reliability.

Furthermore, in the second exemplary embodiment of the present invention, an example in which insulating porous protective layers are formed on the both surfaces of the negative electrode is described. However, the insulating porous protective layer may be formed on only one surface in the case of a separator.

Furthermore, in the second exemplary embodiment, an example in which a funnel-shaped portion and a collection portion are provided to a precipitation tank is described. However, the configuration is not limited to this alone, and the funnel-shaped portion and the collection portion may be provided to a dispersion device. Thus, aggregates and precipitates are further removed, and it is possible to obtain a member for a secondary battery having an insulating porous protective layer that is excellent in uniformity.

Hereinafter, specific Examples of the second exemplary embodiment are described.

### Example 1

Firstly, a negative electrode precursor is produced by the same method as in Example 1 of the first exemplary embodiment.

Next, N-methyl-2-pyrrolidone (NMP) as a solvent and 4 parts by weight of polyvinylidene fluoride (PVDF) as a binder are input into the dispersion device, and a coating paint is dispersed and mixed by the same method as in Example 1 of the first exemplary embodiment.

Next, the mixed and dispersed coating paint is supplied to a precipitation tank that is a coating solution pan of a gravure coater, and allowed to stand still and stored for 24 hours in this state. Then, during still standing storage in the precipitation tank, aggregates of MgO aggregated to the size of about 2 μm to 50 μm and coarse powders are allowed to precipitate and separate, and then collected in a collection portion. Note here that at the time of dispersing and mixing and at the time of still standing storage, circulation and filtration of the coating paint are not carried out. At this time, if necessary, the collection portion provided in the lower part of the precipitation tank is taken off, and aggregates of MgO and coarse powders, and the like, are removed.

Next, after aggregates and precipitates are removed, gravure roll (cylinder) 36 having a diameter of, for example, 50 mm is rotated at the rotation number corresponding to, for example, the peripheral speed of 3 m/s so as to stir the coating paint. Thus, reaggregation is prevented. Then, the coating paint in the precipitation tank that is a coating solution pan is supplied to the surface of the gravure roll. Then, a negative electrode precursor of a member for a secondary battery produced as mentioned above is sent and supplied onto the gravure roll. In addition, the coating paint filled in a recess of the gravure roll is continuously coated on at least one surface of the negative electrode mixture layer of the negative electrode precursor.

Next, the coating paint is coated and then dried and hardened so as to form an insulating porous protective layer having a thickness of about 2 μm on the negative electrode mixture layer. In addition, an insulating porous protective layer is formed also on the other surface of the negative electrode precursor by a similar method. Thus, a negative electrode is produced.

The negative electrode produced by the above-mentioned method and a battery produced by using the negative electrode by a production method mentioned below are defined as sample 1.

### Examples 2 to 5

In each of Examples 2 to 5, a negative electrode as a member for a secondary battery is produced respectively in the same manner as in Example 1 except that α-Al₂O₃ (alumina) having an average particle diameter D50 of 0.7 μm, anatase-TiO₂ (titania) having D50 of 0.7 μm, SiO₂ (silica) having D50 of 0.7 and ZrO₂ (zirconia) having D50 of 0.9 μm are used as an inorganic oxide filler respectively. At this time, each viscosity of the coating paint is 40 mPa·s, 45 mPa·s, 50 mPa·s and 42 mPa·s.

The negative electrodes of samples produced in this way and batteries produced by the below-mentioned production method by using these negative electrodes are defined as samples 2 to 5, respectively.

### Examples 6 to 11

In each of Examples 6 to 11, a negative electrode as a member for a secondary battery is produced respectively in the same manner as in Example 1 except that each viscosity of the coating paint is set to 10 mPa·s, 120 mPa·s, 570 mPa·s, 1005 mPa·s, 1840 mPa·s and 3000 mPa·s, respectively.

The negative electrodes of samples produced in this way and batteries produced by the below-mentioned production method by using these negative electrodes are defined as samples 6 to 11, respectively.

### Comparative Examples 1 and 2

In each of Comparative Examples 1 and 2, a negative electrode as a member for a secondary battery is produced respectively in the same manner as in Example 1 except that each viscosity of the coating paint is set to 8 mPa·s and 3210 mPa·s, respectively.

The negative electrodes of samples produced in this way and batteries produced by the below-mentioned production method by using these negative electrodes are defined as samples C1 and C2, respectively.

### Comparative Example 3

A negative electrode as a member for a secondary battery is produced in the same manner as in Example 1 except that the coating paint is produced by a method of circulating the coating paint so as to filtrate aggregates instead of a method of precipitating and separating aggregates and coarse powders in a precipitation tank.

The negative electrode of a sample produced in this way and a battery produced by the below mentioned production method by using this negative electrode is defined as sample C3.

### Comparative Examples 4 to 6

In each of Comparative Examples 4 to 6, a negative electrode as a member for a secondary battery is produced in the same manner as in Example 1 except that the viscosity of the coating paint is set to 125 mPa·s, 498 mPa·s, and 1032 mPa·s and that the coating paint is produced by the method of circulating the coating paint so as to filtrate aggregates instead of the method of precipitating and separating aggregates and coarse powders in the precipitation tank.

The negative electrodes of samples produced in this way and batteries produced by the below-mentioned production method by using these negative electrodes are defined as samples C1 to C4, respectively.

The negative electrodes as a member for a secondary battery produced as mentioned above are evaluated for the paint stability and coating defects as mentioned below similar to the first exemplary embodiment.

Firstly, the solid content change rate generated while the coating paint is allowed to stand still and stored is measured, and “paint stability” is evaluated from the stability of the dispersion state of the coating paint by the similar method as in the first exemplary embodiment.

Furthermore, a coated film of an insulating porous protective layer having a thickness of about 2 μm is produced on the surface of the negative electrode mixture layer of the negative electrode, and the “coating defect” is evaluated by the similar method as in the first exemplary embodiment.

The parameters and evaluation results of samples 1 to 11 and samples C1 to C6 are shown in Table 2.

TABLE 2

| | Parameter | | | | | | | |
|---|---|---|---|---|---|---|---|---|
| | Inorganic | | | | | Evaluation results | | |
| | oxide filler | Particle | | | | | | End-point |
| | (specific | diameter | Viscosity | | | Paint | Coating | temperature |
| | gravity) | D50 (μm) | (mPa · s) | (4) | (5) | stability | defect | (° C.) |
| Sample 1 | MgO | 0.98 | 49 | Y | N | ∘ | ∘ | 86 |
| | (3.585) | | | | | | | |
| Sample 2 | α-Al₂O₃ | 0.7 | 40 | Y | N | ∘ | ∘ | 87 |
| | (3.98) | | | | | | | |
| Sample 3 | anatase-TiO₂ | 0.7 | 45 | Y | N | ∘ | ∘ | 86 |
| | (3.9) | | | | | | | |
| Sample 4 | SiO₂ | 0.7 | 50 | Y | N | ∘ | ∘ | 88 |
| | (2.15) | | | | | | | |
| Sample 5 | ZrO₂ | 0.9 | 42 | Y | N | ∘ | ∘ | 88 |
| | (6.0) | | | | | | | |
| Sample 6 | MgO | 0.98 | 10 | Y | N | ∘ | ∘ | 84 |
| | (3.585) | | | | | | | |
| Sample 7 | MgO | 0.98 | 120 | Y | N | ∘ | ∘ | 86 |
| | (3.585) | | | | | | | |
| Sample 8 | MgO | 0.98 | 570 | Y | N | ∘ | ∘ | 88 |
| | (3.585) | | | | | | | |
| Sample 9 | MgO | 0.98 | 1005 | Y | N | ∘ | ∘ | 88 |
| | (3.585) | | | | | | | |
| Sample 10 | MgO | 0.98 | 1840 | Y | N | ∘ | ∘ | 85 |
| | (3.585) | | | | | | | |
| Sample 11 | MgO | 0.98 | 3000 | Y | N | ∘ | ∘ | 87 |
| | (3.585) | | | | | | | |
| Sample C1 | MgO | 0.98 | 8 | Y | N | ▴ | ▴ | 92 |
| | (3.585) | | | | | | | |
| Sample C2 | MgO | 0.98 | 3210 | Y | N | ▴ | ▴ | 92 |
| | (3.586) | | | | | | | |
| Sample C3 | MgO | 0.98 | 49 | N | Y | x | x | 105 |
| | (3.587) | | | | | | | |
| Sample C4 | MgO | 0.98 | 125 | N | Y | x | x | 101 |
| | (3.588) | | | | | | | |
| Sample C5 | MgO | 0.98 | 498 | N | Y | x | x | 105 |
| | (3.589) | | | | | | | |
| Sample C6 | MgO | 0.98 | 1032 | N | Y | x | x | 102 |
| | (3.590) | | | | | | | |

(4) Precipitation and separation in gravure coater is carried out (Y) or not carried out (N)
(5) Circulation is carried out (Y) or not carried out (N)

As is apparent from Table 2, in samples 1 to 5, the coating paint used for forming the insulating porous protective layer produced by the manufacturing method in accordance with the second exemplary embodiment of the present invention is excellent in the paint stability and is free from coating defects regardless of the materials of the inorganic oxide filler. This is because the coating paint is allowed to stand still and stored in a precipitation tank (coating solution pan), thereby aggregates and precipitates of the inorganic oxide filler can be removed efficiently. This is also because reaggregates having a size of not smaller than the film thickness are not generated by the stirring by the rotation of a gravure roll.

Furthermore, in samples 6 to 11 and samples C1 to C2, when a viscosity of the coating paint is in the range from 10 mPa·s to 3000 mPa·s, a negative electrode as a member for a secondary battery provided with a porous protective layer that is excellent in the paint stability and free from coating defects can be formed. This is because aggregates of the inorganic oxide filler are removed efficiently in this viscosity range in a predetermined time.

On the other hand, in sample C1 having a viscosity of less than 10 mPa·s or sample C2 having a viscosity of more than 3000 mPa·s, the solid content change rate is 1% to 2% and due to the aggregates thereof and the like, the paint stability is reduced. Furthermore, in the porous protective layers thereof, coating defects such as a coating streak having a width of 1 mm or less and a grain are generated. The reason for this can be thought as follows. In the case of sample C1 having a viscosity of less than 10 mPa·s, since the viscosity is too low, aggregates are easily generated even when stirring is carried out, so that the composition change is large and the film porosity becomes ununiform. In sample C2 having a viscosity of more than 3000 mPa·s, although aggregation itself does not easily occur, when aggregation occurs, aggregates are not easily precipitated but remain in the coating paint.

Furthermore, sample 1 is compared with samples C3 to C6. Even when the viscosity of the coating paint is in the optimal range, if precipitation and separation are not carried out in the precipitation tank that is a coating paint solution pan of the gravure coater, the solid content change rate is 2% or more even when circulation and filtration are carried out. Therefore, a coating streak having a width of 1 mm or more and a grain are generated. This is thought to be because in a case where the coating paint is produced only by circulation and filtration without carrying out precipitation and separation, when the coating paint comes out from the circulation line and returns to the mixing tank again, reaggregation of the inorganic oxide filler occurs.

Hereinafter, by using a negative electrode that is a member for a secondary battery of each sample in which an insulating porous protective layer is formed on the surface of a negative electrode mixture layer of the negative electrode, secondary batteries are produced respectively and the characteristics are evaluated. At this time, the secondary battery is produced by the method as in the first exemplary embodiment and the battery has a diameter of 18 mm, height of 65 mm and design capacity of 2600 mAh. These are defined as batteries of samples, respectively.

Each of the batteries of samples produced as mentioned above is subjected to a charging and discharging cycle test, in which the each battery is charged at environmental temperature of 25° C. at constant voltage of 4.2V (maximum electric current: 1 A and minimum electric current: 100 mA), 30 minutes later, discharged at constant current of 200 mA until the end voltage of 3.0 V, and this charging and discharging is repeated 500 times.

Furthermore, in order to evaluate the safety, a nail penetration test is carried out by the following conditions.

Firstly, at environmental temperature of 20° C., an iron wire nail having a diameter of 2.7 mm is penetrated from the side surface of the charged battery at the speed of 5 mm/s. Then, the end-point temperature after 90 seconds in the vicinity of the penetration portion of the battery is measured.

As a result, in batteries of samples 1 to 11, the ratio of the discharge capacity in the 300th charge and discharge cycle with respect to the initial discharge capacity is 80% or more. On the other hand, in batteries of samples C1 to C6, the ratio is 50% to 85%, showing that the variation is large and the discharge capacity is remarkably reduced.

This is thought to be because aggregates are removed in the precipitation tank, so that it is possible to obtain a secondary battery having a small variation in which a battery reaction is carried out uniformly all over the electrode by the high uniformity of the film thickness and the homogeneity such as the film porosity even in a case where the negative electrode has a thin insulating porous protective layer having such a small thickness as 2

Furthermore, as shown in Table 2, the end-point temperatures after 90 seconds in the nail penetration test of batteries of samples 1 to 11 are 90° C. or less. Temperature rise is relatively small. This is thought to be because the thermal runaway is suppressed due to the uniformly formed heat resistant porous protective layer.

On the other hand, in the batteries of samples C1 and C2, the temperature is 90° C. or more due to the ununiformity of the film porosity. Furthermore, in the batteries of samples C3 to C6, the temperature is 100° C. or more, showing a further large temperature rise.

As mentioned above, aggregates and precipitates are removed in a precipitation tank that is a coating solution pan of a gravure coater and reaggregation is prevented by the stirring by the rotation of the gravure roll, so that an insulting porous protective layer having a uniform thickness and homogeneous composition is formed on the surface of the negative electrode mixture layer by gravure printing. Thus, a negative electrode is produced. With the negative electrode, a secondary battery being excellent in the battery property and the reliability and having a high safety can be produced.

### Third Exemplary Embodiment

The third exemplary embodiment of the present invention is different from the second exemplary embodiment in that precipitation tank 332 provided to gravure coater 300 of the second exemplary embodiment is defined as a second precipitation tank and that a first precipitation tank for allowing the coating paint to stand still and to be stored is provided. Since the other configuration is the same as that in the second exemplary embodiment, the same reference numerals are given to the same configuration with reference to corresponding drawings. The description of the configuration and the production method of the secondary battery, which are the same as in the first exemplary embodiment, is omitted.

In a method for manufacturing a member for a secondary battery in accordance with the third exemplary embodiment of the present invention, firstly, at least an inorganic oxide filler, a solvent and a binder are dispersed and mixed, and then aggregates or coarse powders precipitated during the still standing storage in the first precipitation tank are removed in advance. Thereafter, aggregates and precipitates, which are generated in the middle of supplying from the first precipitation tank to the second precipitation tank or during the storage in the second precipitation tank, are further removed before gravure printing. Thereafter, the coating paint, from which aggregates and precipitates have been removed doubly in the first precipitation tank and the second precipitation tank, is coated on the surface of the negative electrode mixture layer of the negative electrode so as to form an insulating porous protective layer.

Then, as shown in FIG. 1, negative electrode 1 provided with an insulating porous protective layer and positive electrode 2 are wound with separator 3 interposed therebetween, so that a secondary battery that is excellent in the safety and the reliability such as a heat resistance property can be realized.

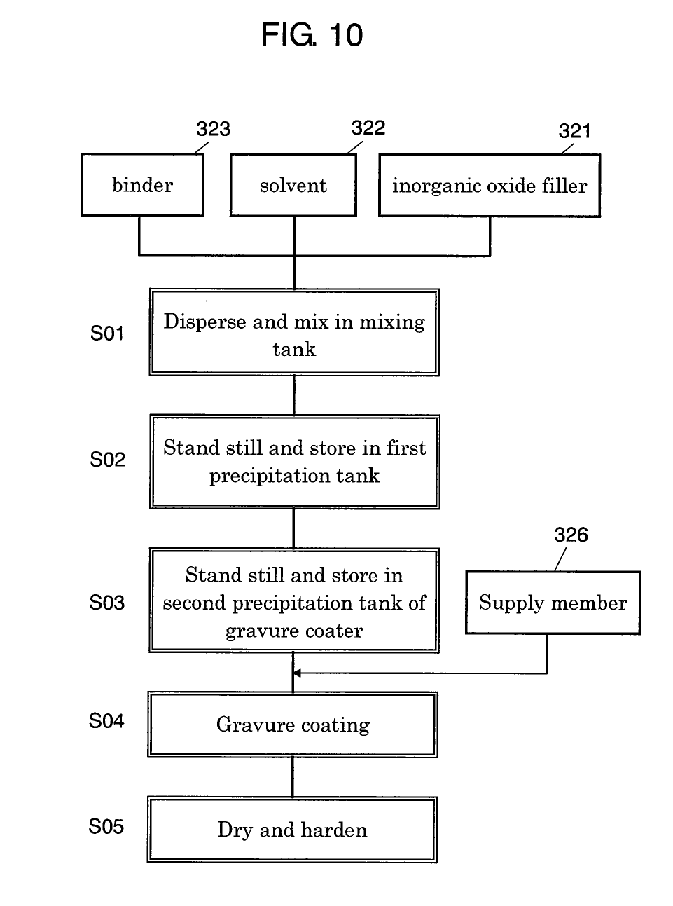

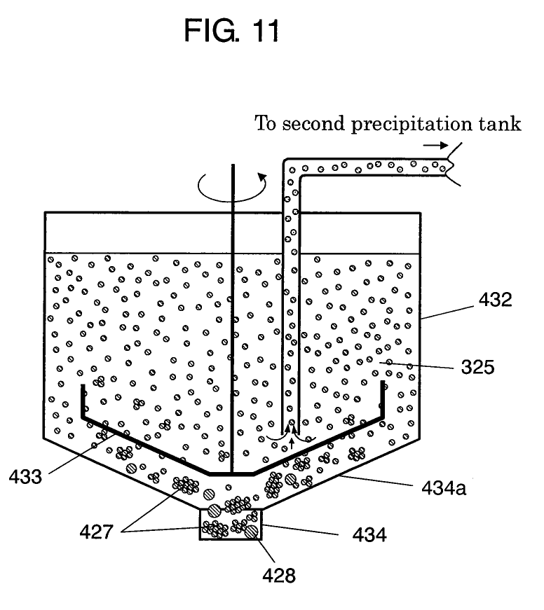

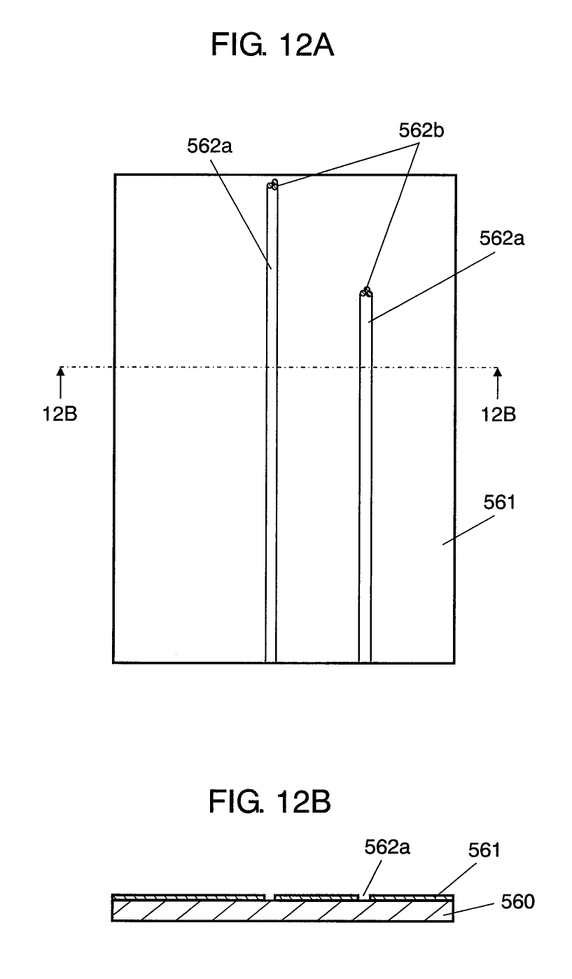

Hereinafter, a method for manufacturing a member for a secondary battery provided with an insulating porous protective layer is described with reference to FIGS. 10 and 11.

FIG. 10 is a flowchart showing a method for manufacturing a member for a secondary battery in accordance with the third exemplary embodiment of the present invention.

FIG. 11 is a conceptual sectional view showing a first precipitation tank of an apparatus for manufacturing a member for a secondary battery in accordance with the third exemplary embodiment of the present invention.

Firstly, as shown in FIG. 10, similar to the second exemplary embodiment, for example, at least inorganic oxide filler 321, solvent 322 and binder 323 are input into a dispersion device (not shown) and they are dispersed and mixed so as to obtain coating paint 325 as a mixture, and the viscosity of coating paint 325 is adjusted to, for example, 50 mPa·s in the dispersion device (S01). Since the specific method, adjustment range of the viscosity, and the like, are the same as those of the first exemplary embodiment, the description therefore is omitted herein.

Next, as shown in FIGS. 10 and 11, coating paint 325 dispersed and mixed in a dispersion device is supplied into first precipitation tank 432, and stored in a still-standing state for, for example, several hours to one day. Note here that the storage time is determined by considering the productivity and the state of aggregates, and it is not determined uniquely. When the coating paint is stored in a still standing state in this way, coarse powders and aggregates of the inorganic oxide filler, which are not dispersed and mixed, are precipitated as precipitates. Furthermore, inorganic oxide fillers that tend to aggregate with each other are aggregated and then precipitated as aggregate 427.

Next, precipitates such as aggregates 427 and coarse powders 428 of the inorganic oxide filler in coating paint 325, which are precipitated while the coating paint is allowed to stand still and stored in first precipitation tank 432, are removed by funnel-shaped portion 434a and collection portion 434 provided in the lower part of first precipitation tank 432 (S02). At this time, in general, 1% to 2% of inorganic oxide filler is removed as aggregates 427 from coating paint 325.

Next, as shown in FIG. 11, by using a stirring blade such as an anchor of stirrer 433 provided in first precipitation tank 432, coating paint 325 is stirred at the peripheral speed of, for example, 3 m/s.

Thus, precipitates such as aggregates and coarse powders of inorganic oxide fillers that tend to aggregate with each other are removed in advance, and the coating paint can be stored for a long time while it is prevented from being reaggregated by stirring. Furthermore, by removing precipitates such as aggregates and coarse powders of inorganic oxide fillers that tend to aggregate with each other in advance, even if coating paint 325 retains in a supplying pipe and the like in the following process for supplying coating paint 325 to gravure coater, aggregates and precipitates are not generated for a long time. As a result, the coating paint can be supplied to second precipitation tank that is a coating solution pan of the gravure coater in a state in which inorganic oxide fillers without containing aggregates and precipitates of large coarse powder are dispersed, and therefore the clogging of the supplying pipe can be prevented.

Note here that since the gravure coater to which the coating paint is supplied from first precipitation tank 432 is the same as that of the second exemplary embodiment, in the following steps, the precipitation tank of the second exemplary embodiment is defined as second precipitation tank 332 and the description is carried out with reference to FIGS. 8A, 8B and 9.

Next, as shown in FIGS. 10, 8A and 8B, coating paint 325, from which precipitates of large coarse powders 428 and aggregates 427 have been removed in first precipitation tank 432, are supplied to second precipitation tank 332 that is a coating solution pan of gravure coater 300 and allowed to stand still and stored therein. At this time, the time of the still standing storage depends upon the time of supplying from the first precipitation tank to the second precipitation tank. That is to say, in the case where the coating paint is supplied from the first precipitation tank through the supplying pipe without retention, the still standing storage is not particularly required. However, for example, the retention time is, for example, about 10 days, the coating paint is allowed to stand still and stored for several hours to about one clay similar to the first precipitation tank.

Thus, aggregates 327 or precipitates of the inorganic oxide filler generated by retention and existing in second precipitation tank 332 are removed again in funnel-shaped portion 334a and collection portion 334 provided in the lower part of second precipitation tank 332 before gravure printing (S03).

Furthermore, as shown in FIGS. 8A and 8B, after aggregates and the like are removed, by rotating gravure roll (cylinder) 336 of gravure coater 300, coating paint 325 is stirred. With this rotation of gravure roll 336, coating paint 325 is stirred slowly, thus preventing the aggregation over time of the inorganic oxide filler. Thus, reaggregation is further prevented.

In this way, coarse powders or aggregates are removed in first precipitation tank 432 in advance without carrying out circulation and filtration, and aggregates generated in the supplying pipe and the like during storage (retention) are removed again in second precipitation tank 332 before gravure printing.

Next, as shown in FIGS. 9 and 10, gravure roll 336 is rotated in second precipitation tank 332 that is a coating solution pan of gravure coater 300, and coating paint 325 is stirred and at the same time, it is supplied to the surface of the gravure roll. Thus, with the rotation of gravure roll 336, coating paint 325 is prevented from being reaggregated and stably supplied onto the surface of gravure roll 336 while it is uniformly dispersed.

Then, for example, long negative electrode precursor 326 including a current collector and a negative electrode mixture layer is sent out and supplied onto gravure roll 336 to which coating paint 325 is supplied.

Furthermore, coating paint 325 is gravure coated on one surface of the negative electrode mixture layer (not shown) of long negative electrode precursor 326 via gravure roll 336 (S04). Note here that specific method is the same as in the second exemplary embodiment and the description therefor is omitted herein.

Next, as shown in FIG. 10, the coated film is dried and hardened so as to form an insulating porous protective layer having a thickness of, for example, about 2 μm (S05). Similarly, although not shown, coating paint 325 is continuously coated on the surface of the negative electrode mixture layer formed on the other surface side of negative electrode precursor 326, and then dried and hardened so as to form an insulating porous protective layer having a thickness of about 2 μm. Thus, negative electrode 1 is produced.

According to the above-mentioned method, a coating paint having a stable composition and without containing aggregates and the like for a long time can be obtained at the time of gravure coating regardless of the storage state and storage conditions of the coating paint before gravure coating. Then, this coating paint is used and stirred with a gravure roll to prevent the aggregation of the coating paint. Thereby, a thin insulating porous protective layer being free from a coating streak and a grain can be formed on the negative electrode precursor.

Furthermore, in a secondary battery produced by using a negative electrode as a member for a secondary battery provided with an insulating porous protective layer, a battery reaction is carried out uniformly. For example, a charge and discharge cycle characteristic, the reliability such as a heat resistance property can be improved remarkably.

According to the third exemplary embodiment, the coating paint can be stored for a long time and a member for a secondary battery provided with an insulating porous protective layer that is free from defects such as a coating streak can be produced by gravure coating efficiently.

Furthermore, since the generation of aggregates can be suppressed as much as possible before forming an insulating porous protective layer, it is possible to form a film to the thickness of about 2 μm, which was conventionally for example, 5 μm in order to enhance the safety. Accordingly, since the number of winding the member for a secondary battery is increased, it is possible to realize a secondary battery having a large battery capacity.

Herein, as shown in FIGS. 11 and 8A to 9, an apparatus for manufacturing a member for a secondary battery includes a dispersion device (not shown) for dispersing and mixing coating paint 325 including inorganic oxide filler 321, solvent 322 and binder 323; first precipitation tank 432 having funnel-shaped portion 434a at the bottom; and gravure coater 300 including second precipitation tank 332 having funnel-shaped portion 334a at the bottom and gravure roll 336. Collection portions 334 and 434 for collecting precipitates such as aggregates 327 and 427 or coarse powders 428 of an inorganic oxide filler are provided in the lower part of funnel-shaped portions 334a and 434a of first precipitation tank 432 and second precipitation tank 332.

By using the above-mentioned manufacturing apparatus, firstly, coating paint 325 dispersed and mixed in the dispersion device is allowed to stand still and stored in first precipitation tank 432 and large coarse powders or aggregates are removed. Next, aggregates and the like, which are generated when the coating paint is stored for a long time without carrying out circulation and filtration are further removed in second precipitation tank 332 that is a coating solution pan of the gravure coater.

Thus, without adding large circulation equipment or filtration equipment to a manufacturing apparatus, a manufacturing apparatus capable of manufacturing a small and inexpensive member for a secondary battery can be produced.

Furthermore, with funnel-shaped portion 434a provided at the bottom of first precipitation tank 432 and funnel-shaped portion 334a provided at the bottom of second precipitation tank 332, large coarse powders, aggregates and aggregates 327 and 427 of the inorganic oxide filler generated for a long-time storage can be reliably collected in collection portions 334 and 434 at the tip of the funnel shaped portion. In addition, by providing collection portions 334 and 434 at the tip of funnel-shaped portions 334a and 434a, it is possible to prevent precipitates once entering collection portions 334 and 434 from floating into the coating paint again. As a result, precipitates such as aggregates 327 and 427 and coarse powders 428 of the inorganic oxide filler can be collected easily and reliably.

Note here that collection portions 334 and 434 may be provided detachably with respect to first precipitation tank 432 and second precipitation tank 332, for example, provided in a cartridge form. Thus, aggregates and precipitates collected in collection portions 334 and 434 can be collected and discarded on a regular basis or continuously.

Furthermore, by providing stirrer 433 in first precipitation tank 432, since the stirring condition can be controlled by stirrer 433 and reaggregation of the coating paint can be prevented, further long-time storage becomes possible. As a result, a member for a secondary battery with high quality can be manufactured stably for a long time.

In the third exemplary embodiment, an example in which a step for producing a coating paint by dispersing and mixing is carried out in a dispersion device in the above-mentioned manufacturing method and a manufacturing apparatus. However, the configuration is not limited to this alone. For example, a step of producing a coating paint by dispersing and mixing an inorganic oxide filler, a solvent and a binder may be also carried out in the first precipitation tank. In this case, it is desirable that the first precipitation tank includes a dispersion blade such a disper and a stirring blade such as anchor. Thus, since dispersing and mixing, still standing storage and removing can be carried out in the same first precipitation tank, it is possible to realize a manufacturing apparatus with simpler configuration.

Furthermore, in the third exemplary embodiment, an example in which an insulating porous protective layer is formed on the surface of the negative electrode mixture layer of the negative electrode is described. However, the configuration is not limited to this alone. For example, the insulating porous protective layer may be formed by coating on any one of a positive electrode and a separator. Thus, similar to the case of the negative electrode, it is possible to realize a secondary battery being excellent in the safety and the reliability.

Furthermore, in the third exemplary embodiment, an example in which a funnel-shaped portion and a collection portion are provided in a first precipitation tank and a second precipitation tank is described. The configuration is not limited to this alone. A funnel-shaped portion and a collection portion may be also provided a dispersion device. Thus, aggregates and precipitates are removed more reliably, so that it is possible to obtain a member for a secondary battery provided with a porous protective layer that is excellent in uniformity.

Hereinafter, specific Examples of the third exemplary embodiment are described.

### Example 1

Firstly, a negative electrode precursor is produced by the same method as in Example 1 of the first exemplary embodiment.

Next, N-methyl-2-pyrrolidone (NMP) as a solvent and 4 parts by weight of polyvinylidene fluoride (PVDF) as a binder are input into a dispersion device, and coating paint is dispersed and mixed by the same method as in Example 1 of the first exemplary embodiment.

Next, the coating paint mixed and dispersed in the dispersion device is supplied to a first precipitation tank, and allowed to stand still and stored for 24 hours in this state. Then, during still standing storage in the first precipitation tank, precipitates such as aggregates of MgO, which are aggregated to the size of about 2 μm to 50 μm, and coarse powders are precipitated and separated, and then they are collected in a collection portion. Note here that at the time of dispersing and mixing and at the time of storage, circulation and filtration of the coating paint are not carried out. At this time, if necessary, the collection portion provided in the lower part of the first precipitation tank is taken off and precipitates such as aggregates of MgO or coarse powders are removed.

Next, the coating paint, from which aggregates and precipitates have been removed, is supplied to a second precipitation tank that is a coating solution pan of the gravure coater. Herein, a supplying time from the first precipitation tank to the second precipitation tank is defined as T time.

Next, according to the above-mentioned T time, the still standing storage time in the second precipitation tank is set to, for example, three hours to one day, and the coating paint is stored. Aggregates of the inorganic oxide filler generated during T time are allowed to precipitate during the still standing storage and removed again in the collection portion provided in the lower part of the second precipitation tank before gravure printing. Note here that during the still standing storage in the second precipitation tank, circulation and filtration of the coating paint are not carried out. At this time, if necessary, the collection portion provided in the lower part of the second precipitation tank is taken off and aggregated and precipitated MgO is discarded.

Next, after aggregates and precipitates are removed by allowing the coating paint to stand still and storing for a predetermined time, a gravure roll (cylinder) having a diameter of, for example, 50 mm is rotated at the rotation number corresponding to, for example, the peripheral speed of 3 m/s so as to stir the coating paint in order to prevent the reaggregation of the coating paint. Then, the coating paint in the precipitation tank that is a coating solution pan is supplied to the surface of the gravure roll.

Then, the negative electrode precursor of a member for a secondary battery produced as mentioned above is sent and supplied onto the gravure roll. Then, the coating paint filled in a recess of the gravure roll is continuously coated on at least one surface of the negative electrode mixture layer of the negative electrode precursor.

Next, the coating paint is coated, then dried and hardened so as to form an insulating porous protective layer having a thickness of about 2 μm on the negative electrode mixture layer. In addition, an insulating porous protective layer is formed also on the other surface of the negative electrode precursor by a similar method. Thus, a negative electrode is produced.

Herein, a negative electrode as a member for a secondary battery produced with the T time set to three days and a battery produced by using this negative electrode are defined as sample 1-1. Similarly, a negative electrode as a member for a secondary battery produced with the T time set to ten days and a battery produced by using this negative electrode are defined as sample 1-2.

### Examples 2 to 5

In each of Examples 2 to 5, a negative electrode as a member for a secondary battery is produced respectively in the same manner as in Example 1 except that α-Al₂O₃ (alumina) having an average particle diameter D50 of 0.7 μm, anatase-TiO₂ (titania) having D50 of 0.7 μm, SiO₂ (silica) having D50 of 0.7 μm, and ZrO₂ (zirconia) having D50 of 0.9 μm are used as an inorganic oxide filler, respectively. At this time, each viscosity of the coating paint is 40 mPa·s, 45 mPa·s, 50 mPa·s and 42 mPa·s.

Herein, negative electrodes as a member for a secondary battery produced with the T time set to three days and batteries produced by using the negative electrodes are defined as samples 2-1 to 5-1. Similarly, negative electrodes as a member for a secondary battery produced with the T time set to ten days and batteries produced by using the negative electrodes are defined as samples 2-2 to 5-2.

### Examples 6 to 11

In each of Examples 6 to 11, a negative electrode as a member for a secondary battery is produced respectively in the same manner as in Example 1 except that each viscosity of the coating paint is set to 10 mPa·s, 120 mPa·s, 570 mPa·s, 1005 mPa·s, 1840 mPa·s and 3000 mPa·s, respectively.

Herein, negative electrodes as a member for a secondary battery produced with the T time set to three days and batteries produced by using the negative electrodes are defined as samples 6-1 to 11-1. Similarly, negative electrodes as a member for a secondary battery produced with the T time set to ten days and batteries produced by using the negative electrodes are defined as samples 6-2 to 11-2.

### Comparative Examples 1 and 2

In each of Comparative Examples 1 and 2, a negative electrode as a member for a secondary battery is produced respectively in the same manner as in Example 1 except that the viscosity of the coating paint is set to 8 mPa·s and 3210 mPa·s, respectively.

Herein, negative electrodes as a member for a secondary battery produced with the T time set to three days and batteries produced by using the negative electrodes are defined as samples C1-1 to C2-1. Similarly, negative electrodes as a member for a secondary battery produced with the T time set to ten days and batteries produced by using the negative electrodes are defined as samples C1-2 to C2-2.

### Comparative Example 3

A negative electrode as a member for a secondary battery is produced in the same manner as in Example 1 except that the viscosity of the coating paint is 50 mPa·s and that the coating paint is produced by a method of removing aggregates and precipitates after still standing storage in the first precipitation tank, and not removing aggregates and precipitates generated during the storage in the second precipitation tank.

Herein, a negative electrode as a member for a secondary battery produced with the T time set to three days and a battery produced by using the negative electrode is defined as sample C3-1. Similarly, a negative electrode as a member for a secondary battery produced with the T time set to ten days and a battery produced by using the negative electrodes are defined as sample C3-2.

### Comparative Example 4

A negative electrode as a member for a secondary battery is produced in the same manner as in Example 1 except that the viscosity of the coating paint is 52 mPa·s and that the coating paint is produced by a method of not removing aggregates and precipitates after still standing storage in the first precipitation tank, but separating and removing aggregates and precipitates precipitated during the still standing storage in the second precipitation tank.

Herein, a negative electrode as a member for a secondary battery produced with the T time set to three days and a battery produced by using the negative electrode are defined as sample C4-1. Similarly, a negative electrode as a member for a secondary battery produced with the T time set to ten days and a battery produced by using the negative electrode are defined as sample C4-2.

In the negative electrodes as a member for a secondary battery produced as mentioned above, the coating paint for forming the porous protective layer of the negative electrode is evaluated based on the paint stability and coating defects mentioned below similar to the first exemplary embodiment.

Firstly, the solid content change rate generated in the coating paint after it is stored for three days of T time is measured and “paint stability” is evaluated from the stability of the dispersion state of the coating paint by the same method as in the first exemplary embodiment.

Furthermore, a coated film of an insulating porous protective layer having a thickness of about 2 μm is produced on the surface of the negative electrode mixture layer of the negative electrode and “coating defect” is evaluated by the same method as in the first exemplary embodiment.

The parameters and evaluation results of samples 1-1 to 11-1 and samples C1-1 to C4-1 are shown in Table 3; and the parameters and evaluation results of samples 1-2 to 11-2 and samples C1-2 to C4-2 are shown in Table 4.

TABLE 3

| | Parameter | | | | | | | |
|---|---|---|---|---|---|---|---|---|
| | Inorganic | | | | | Evaluation results | | |
| | oxide filler | Particle | | | | | | End-point |
| | (specific | diameter | viscosity | | | Paint | | temperature |
| | gravity) | D50 (μm) | (mPa · s) | (6) | (7) | stability | (8) | (° C.) |
| Sample 1-1 | MgO | 0.98 | 49 | Y | Y | ∘ | ∘ | 86 |
| | (3.585) | | | | | | | |
| Sample 2-1 | α-Al2O3 | 0.7 | 40 | Y | Y | ∘ | ∘ | 87 |
| | (3.98) | | | | | | | |
| Sample 3-1 | anatase-TiO2 | 0.7 | 45 | Y | Y | ∘ | ∘ | 86 |
| | (3.9) | | | | | | | |
| Sample 4-1 | SiO₂ | 0.7 | 50 | Y | Y | ∘ | ∘ | 88 |
| | (2.15) | | | | | | | |
| Sample 5-1 | ZrO₂ | 0.9 | 42 | Y | Y | ∘ | ∘ | 88 |
| | (6.0) | | | | | | | |
| Sample 6-1 | MgO | 0.98 | 10 | Y | Y | ∘ | ∘ | 84 |
| | (3.585) | | | | | | | |
| Sample 7-1 | MgO | 0.98 | 120 | Y | Y | ∘ | ∘ | 86 |
| | (3.585) | | | | | | | |
| Sample 8-1 | MgO | 0.98 | 570 | Y | Y | ∘ | ∘ | 88 |
| | (3.585) | | | | | | | |
| Sample 9-1 | MgO | 0.98 | 1005 | Y | Y | ∘ | ∘ | 88 |
| | (3.585) | | | | | | | |
| Sample 10-1 | MgO | 0.98 | 1840 | Y | Y | ∘ | ∘ | 85 |
| | (3.585) | | | | | | | |
| Sample 11-1 | MgO | 0.98 | 3000 | Y | Y | ∘ | ∘ | 87 |
| | (3.585) | | | | | | | |
| Sample C1-1 | MgO | 0.98 | 8 | Y | Y | ▴ | ∘ | 92 |
| | (3.585) | | | | | | | |
| Sample C2-1 | MgO | 0.98 | 3210 | Y | Y | ▴ | ∘ | 92 |
| | (3.585) | | | | | | | |
| Sample C3-1 | MgO | 0.98 | 50 | Y | N | ▴ | ∘ | 98 |
| | (3.585) | | | | | | | |
| Sample C4-1 | MgO | 0.98 | 52 | N | Y | ▴ | ∘ | 101 |
| | (3.585) | | | | | | | |

(6) Precipitation and separation after dispersion is carried out (Y) or not carried out (N).
(7) Precipitation and separation in gravure coater is carried out (Y) or not carried out (N).
(8) Coating defect after stored for three days

TABLE 4

| | Parameter | | | | | | |
|---|---|---|---|---|---|---|---|
| | inorganic | | | | | | |
| | oxide filler | particle | | | | Evaluation | |
| | (specific | diameter | Viscosity | | | results | |
| | gravity) | D50 (μm) | (mPa · s) | (6) | (7) | (8) | (9) |
| Sample 1-2 | MgO | 0.98 | 49 | Y | Y | ∘ | ∘ |
| | (3.585) | | | | | | |
| Sample 2-2 | α-Al₂O₃ | 0.7 | 40 | Y | Y | ∘ | ∘ |
| | (3.98) | | | | | | |
| Sample 3-2 | anatase-TiO₂ | 0.7 | 45 | Y | Y | ∘ | ∘ |
| | (3.9) | | | | | | |
| Sample 4-2 | SiO₂ | 0.7 | 50 | Y | Y | ∘ | ∘ |
| | (2.15) | | | | | | |
| Sample 5-2 | ZrO₂ | 0.9 | 42 | Y | Y | ∘ | ∘ |
| | (6.0) | | | | | | |
| Sample 6-2 | MgO | 0.98 | 10 | Y | Y | ∘ | ∘ |
| | (3.585) | | | | | | |
| Sample 7-2 | MgO | 0.98 | 120 | Y | Y | ∘ | ∘ |
| | (3.585) | | | | | | |
| Sample 8-2 | MgO | 0.98 | 570 | Y | Y | ∘ | ∘ |
| | (3.585) | | | | | | |
| Sample 9-2 | MgO | 0.98 | 1005 | Y | Y | ∘ | ∘ |
| | (3.585) | | | | | | |
| Sample 10-2 | MgO | 0.98 | 1840 | Y | Y | ∘ | ∘ |
| | (3.585) | | | | | | |
| Sample 11-2 | MgO | 0.98 | 3000 | Y | Y | ∘ | ∘ |
| | (3.585) | | | | | | |
| Sample C1-2 | MgO | 0.98 | 8 | Y | Y | ∘ | ∘ |
| | (3.585) | | | | | | |
| Sample C2-2 | MgO | 0.98 | 3210 | Y | Y | ∘ | ∘ |
| | (3.585) | | | | | | |
| Sample C3-2 | MgO | 0.98 | 50 | Y | N | ∘ | ▴ |
| | (3.585) | | | | | | |
| Sample C4-2 | MgO | 0.98 | 52 | N | Y | ∘ | ▴ |
| | (3.585) | | | | | | |

(6) Precipitation and separation after dispersion is carried out (Y) or not carried out (N).
(7) Precipitation and separation in gravure coater is carried out (Y) or not carried out (N).
(8) Coating defect after stored for three days
(9) Coating defect after stored for ten days

As is apparent from Table 3, in samples 1-1 to 5-1, the coating paint produced by the manufacturing method in accordance with the third exemplary embodiment of the present invention and stored for three days of T time is excellent in the paint stability and free from coating defects regardless of materials of the inorganic oxide filler. This is because the coating paint is allowed to stand still and stored in the first precipitation tank and the second precipitation tank, respectively, and thereby aggregates and precipitates of the inorganic oxide filler can be removed efficiently. This is also because after aggregates and precipitates are removed, the coating paint is stirred by the rotation of the gravure roll in the second precipitation tank so as to prevent the reaggregation.

In samples 6-1 to 11-1 and samples C1-1 and C2-1, in the range of the viscosity of the coating paint of 10 mPa·s to 3000 mPa·s, the negative electrode having a porous protective layer that is excellent in the paint stability and free from coating defects can be formed. This is because the aggregated inorganic oxide filler is removed efficiently in this range of viscosity in a predetermined time.

On the other hand, in sample C1-1 having a viscosity of less than 10 mPa·s or sample C2-1 having a viscosity of more than 3000 mPa·s, the solid content change rate is 1% to 2% and the paint stability is reduced due to the aggregates thereof and the like. However, when a porous protective layer is formed after the same coating paint is stored in the second precipitation tank, coating defects such as a coating streak do not occur. The reason for this is thought to be as follows. When sample C1-1 having a viscosity of less than 10 mPa·s is used, the viscosity is so low that aggregates are easily generated even if stirring is carried out and composition change is large, and therefore the film porosity becomes ununiform. However, since aggregates are removed in the second precipitation tank again, the coating defects are not generated. In the case of sample C2-1 having a viscosity is more than 3000 mPa·s, since aggregation itself does not tend to occur, aggregation does not occur for a short time, but occurs in the period of time of the evaluation of the paint stability, showing the poor paint stability. However, it is thought that since the T time is such a short as three days, the amount of the aggregates is small and furthermore, coarse powders are removed in the first and second precipitation tanks, coating defects are not generated.

Furthermore, when sample 1-1 is compared with samples C3-1 to C4-1. Even when the viscosity of the coating paint is in the optimal range, if precipitation and separation are not carried out in the second precipitation tank, the solid content change rate is 1% to 2%. The paint stability is low. However, there is no coating defects are generated in a porous protective layer when the same coating paint is stored for three days. This is thought to be because when T time is about three days, inorganic oxide fillers are not aggregated during storage in the second precipitation tank.

As is apparent from Table 4, in samples 1-2 to 11-2, also in the coating paint stored for ten days of T time, coating defects are not generated regardless of materials of the inorganic oxide filler. This is because even if aggregates are generated in the coating paint during T time, they are removed in the second precipitation tank, coating defects are not generated even when a porous protective layer is formed by gravure printing. In addition, this is because after aggregates and precipitates are removed, the coating paint is stirred by the rotation of the gravure roll and reaggregation is prevented.

Furthermore, in samples C1-2 to C2-2, when the coating paint with three days of T time and ten days of T time are compared with each other, the difference in the coating defects based on the difference of the T time is not observed and excellent results are obtained. This is thought to be because aggregates are removed in the first precipitation tank and the second precipitation tank. Therefore, from Tables 3 and 4, the difference due to the viscosity appears mainly as the paint stability of the coating paint. As a result, it appears as ununiformity of the film porosity due to the composition change.

Similarly, in samples C3-2 to C4-2, when the coating paints with three days of T time and ten days of T time are compared with each other, coating defects of the generation of a coating streak with the width of 1 mm or more and a grain is generated in the case of ten days of T time. This is thought to be because in the case where the coating paint is produced without precipitation and separation in the second precipitation tank, inorganic oxide fillers are reaggregated, so that aggregates are generated during the time for supplying the coating paint to the second precipitation tank. Furthermore, when aggregates and precipitates are not precipitated and separated in the first precipitation tank and they are precipitated and separated only in the second precipitation tank, aggregates and precipitates cannot be removed sufficiently.

Hereinafter, the property of each secondary battery produced by using each sample, in which an insulating porous protective layer is formed on the surface of the negative electrode mixture layer of the negative electrode, is evaluated. The evaluation results are shown in Table 3 mentioned above. At this time, the secondary battery is produced to have a diameter of 18 mm, height of 65 mm and design capacity of 2600 mAh by the same method shown in the first exemplary embodiment. These are defined as batteries of samples.

Then, each of the produced samples of secondary batteries is evaluated in a charge and discharge cycle test and a nail penetration test in order to evaluate the safety.

As a result, in batteries of samples 1-1 to 11-1, the ratio of the discharge capacity in the 300th charge and, discharge cycle with respect to the initial discharge capacity is 80% or more. On the other hand, in batteries of samples C1-1 to C4-1, the ratio is 50% to 85%, showing that the variation is large and the discharge capacity is remarkably reduced.

This is thought to be because as a result of removing aggregates in two stages, that is, removing in the first precipitation tank and the second precipitation tank, even in a negative electrode having a 2 μm-thick insulating porous protective layer, a battery reaction is carried out uniformly in the entire electrode due to the highly uniform film thickness and homogeneous film porosity, and a secondary battery with small variation can be obtained.

Furthermore, as shown in Table 3, the end-point temperatures after 90 seconds in the nail penetration test of batteries of samples 1-1 to 11-1 are 90° C. or less. The temperature rise is relatively small. This is thought to be because the thermal runaway is suppressed due to the uniformly formed heat resistant porous protective layer.

On the other hand, in the batteries of samples C1-1 and C2-1, the temperature is 90° C. or more due to the ununiformity of the film porosity. Furthermore, in the batteries of samples C3-1 and C4-1, the temperature is around 100° C., showing a further large temperature rise.

As mentioned above, by using a negative electrode having an insulating porous protective layer with a uniform thickness and homogeneous composition on the surface of the negative electrode mixture layer by gravure printing in which aggregates and precipitates are removed in two precipitation tanks and further generated aggregates are prevented, a secondary battery being excellent in the battery property and the reliability and having a high safety can be obtained.

Note here that each exemplary embodiment of the present invention describes an example of a cylindrical secondary battery having a winding type electrode group. However, the type is not limited to this alone. For example, the present invention can be also applied to a flat-shaped battery, a winding-type prismatic-cylindrical battery or a laminated prismatic battery.

### INDUSTRIAL APPLICABILITY

According to the present invention, a member for a secondary battery including an insulating porous protective layer with uniform thickness and homogeneous composition can be manufactured by gravure printing in a high yield and stably by removing aggregates and precipitates from a coating paint in advance. Therefore, it can contribute to the improvement of the safety and the reliability of lithium secondary batteries which are highly expected to be demanded in the future.

1. A method for manufacturing a member for a secondary battery, the method comprising at least:
(i) dispersing and mixing an inorganic oxide filler, a solvent and a binder so as to produce a coating paint;
(ii) supplying the coating paint to a gravure coater; and
(iii) coating the coating paint to a member via a gravure roll;
wherein the (i) or (ii) includes allowing the coating paint to stand still and removing an aggregate and a precipitate of the inorganic oxide filler.

2. The method of claim 1, wherein the (i) comprises:
(i-A) dispersing, mixing and adjusting the coating paint including at least the inorganic oxide filler, the solvent and the binder;
(i-B) allowing the coating paint to stand still and removing an aggregate and a precipitate of the inorganic oxide filler; and
(i-C) storing the coating paint from which the aggregate and the precipitate of the inorganic oxide filler have been removed while stirring.

3. The method of claim 2, wherein the (i-B) and (i-C) are carried out in a mixing tank in which the coating paint is dispersed and mixed.

4. The method of claim 2, wherein the (i-B) is carried out in a precipitation tank to which the coating paint is input.

5. The method of claim 1, wherein the (ii) includes:
supplying the coating paint to a precipitation tank provided in the gravure coater, allowing it to stand still, and removing the aggregate and precipitate of the inorganic oxide filler.

6. The method of claim 5, wherein the precipitation tank is defined as a second precipitation tank; and the (ii) comprises:
(ii-A) supplying the coating paint to a first precipitation tank, allowing it to stand still, and removing the aggregate and the precipitate of the inorganic oxide filler in the first precipitation tank; and
(ii-B) supplying the coating paint obtained in the (ii-A) to the second precipitation tank provided in the gravure coater, allowing it to stand still, and removing the aggregate and the precipitate of the inorganic oxide filler.

7. The method of claim 5, wherein the coating paint is stirred by a rotation of the gravure roll.

8. The method of claim 1, wherein the member includes any of a positive electrode, a negative electrode and a separator.

9. The method of claim 1, wherein as the inorganic oxide filler, an inorganic oxide including at least one of alumina, magnesia, silica, zirconia and titania or a complex oxide thereof is used.

10. The method of claim 1, wherein a viscosity of the coating paint is 10 mPa·s or more and 3000 mPa·s or less.

11. An apparatus for manufacturing a member for a secondary battery, comprising:
a dispersion device for dispersing and mixing a coating paint including an inorganic oxide filler, a solvent and a binder; and
a gravure coater including a precipitation tank and a gravure roll to which the coating paint is supplied and;
wherein any one of the dispersion device and the gravure coater is provided with a collection portion for collecting an aggregate and a precipitate of the inorganic oxide filler.

12. The apparatus of claim 11, wherein the dispersion device comprises:
a mixing tank in which the coating paint is prepared by mixing and dispersing;
a precipitation tank including a funnel-shaped portion provided at a bottom to which the coating paint is supplied and an aggregate and a precipitate of the inorganic oxide filler are collected, and a collection portion provided in a lower part of the funnel-shaped portion; and
a storage tank for storing the coating paint while stirring.

13. The apparatus of claim 11, wherein the precipitation tank of the gravure coater comprises a funnel-shaped portion provided at a bottom to which the coating paint is supplied, and a collection portion provided in a lower part of the funnel-shaped portion.

14. The apparatus of claim 13, wherein the precipitation tank is defined as a second precipitation tank,
the apparatus further comprises a first precipitation tank having a funnel-shaped portion at a bottom in which the coating paint is allowed to stand still, and
a collection portion is provided in a lower part of the funnel-shaped portions of the first precipitation tank and the second precipitation tank.

15. The apparatus of claim 11, wherein the collection portion is provided detachably.

16. A secondary battery comprising a member for a secondary battery produced by a manufacturing method of claim 1, which comprises a positive electrode and a negative electrode capable of reversibly inserting and extracting a lithium ion, a separator, and an electrolyte.
